(19) United States
(12) Patent Application Publication
(10) Pub. No.: US 2026/0063879 A1
(43) Pub. Date: Mar. 5, 2026

(54) IMAGING OPTICAL SYSTEM, PROJECTION TYPE DISPLAY DEVICE, AND IMAGING APPARATUS

(71) Applicant: FUJIFILM Corporation, Tokyo (JP)

(72) Inventors: Yukiko NAGATOSHI, Saitama (JP); Masaru AMANO, Saitama (JP)

(73) Assignee: FUJIFILM Corporation, Tokyo (JP)

(21) Appl. No.: 19/292,328

(22) Filed: Aug. 6, 2025

(30) Foreign Application Priority Data
Aug. 27, 2024 (JP) 2024-145684

(51) Int. Cl. G02B 13/16; G02B 7/02; G02B 13/00; G02B 13/18; G02B 15/14

(52) U.S. Cl. CPC G02B 13/16; G02B 7/025; G02B 13/0095; G02B 13/18; G02B 15/146

(57) ABSTRACT

The imaging optical system consists of a first optical system and a second optical system along an optical path in order from an enlargement side to a reduction side. An intermediate image is formed between the first optical system and the second optical system. The imaging optical system satisfies a conditional expression of 1.73<tan ωm<5 regarding a maximum half angle of view ωm of the enlargement side. The imaging optical system satisfies predetermined conditional expressions regarding a curvature radius of an LA lens disposed adjacent to the reduction side of a longest lens spacing that is a longest spacing among spacings on an optical axis between lenses in the imaging optical system and a curvature radius of an LB lens disposed adjacent to the reduction side of the LA lens.

### CROSS-REFERENCE TO RELATED APPLICATIONS

This application claims priority from Japanese Patent Application No. 2024-145684, filed on Aug. 27, 2024, the entire disclosure of which is incorporated herein by reference.

### BACKGROUND OF THE INVENTION

### Technical Field

The present disclosed technology relates to an imaging optical system, a projection type display device, and an imaging apparatus.

### Related Art

Optical systems described below in JP2021-009221A, JP2020-008799A, WO2017/195857A, JP2021-173845A, WO2020/152941A, and JP2023-155932A have been proposed as optical systems applicable to the projection device.

### SUMMARY

A high-resolution imaging optical system where an angle of view is wide and various aberrations are appropriately corrected has been demanded. A level of the demand has increased year by year.

The present disclosure has been made in consideration of the above circumstances, and provides a high-resolution imaging optical system where an angle of view is wide and various aberrations are appropriately corrected, a projection type display device including the imaging optical system, and an imaging apparatus including the imaging optical system.

A first aspect of the present disclosure relates to an imaging optical system that forms an intermediate image at a position conjugate to a reduction-side imaging plane and re-forms the intermediate image on an enlargement-side imaging plane, the imaging optical system consisting of a first optical system and a second optical system along an optical path in order from an enlargement side to a reduction side, in which the intermediate image is formed between the first optical system and the second optical system, and in a case where a lens disposed adjacent to the reduction side of a longest lens spacing that is a longest spacing among spacings on an optical axis between lenses in the imaging optical system is represented by an LA lens, and a lens disposed adjacent to the reduction side of the LA lens is represented by an LB lens, Conditional Expressions (1), (2), and (3) are satisfied.

$$1.73 < tan ω m < 5 \qquad ( 1 )$$

$$0 < ( RAf + RBr ) / ( RAf - RBr ) < 1.5 \qquad ( 2 )$$

$$1 < ( RAr + RBf ) / ( RAr - RBf ) < 10 \qquad ( 3 )$$

Here, a maximum half angle of view of the enlargement side is represented by ωm. A curvature radius of an enlargement-side surface of the LA lens is represented by RAf. A curvature radius of a reduction-side surface of the LA lens is represented by RAr. A curvature radius of an enlargement-side surface of the LB lens is represented by RBf. Each value of the longest lens spacing and om is set at a wide angle end in a case where the imaging optical system is a variable magnification optical system.

According to a second aspect of the present disclosure, in the imaging optical system according to the first aspect, in a case where an air conversion distance of the longest lens spacing is represented by Dmax, a focal length of the imaging optical system is represented by f, and each value of Dmax and f is set at the wide angle end in a case where the imaging optical system is a variable magnification optical system, Conditional Expression (4) represented by

$$10 < D max / \vert f \vert \qquad ( 4 )$$

is satisfied.

According to a third aspect of the present disclosure, in the imaging optical system according to the first aspect, in a case where a distance on the optical axis between the LA lens and the LB lens is represented by DAB, a maximum image height on the reduction-side imaging plane is represented by Ymax, and each value of DAB and Ymax is set at the wide angle end in a case where the imaging optical system is a variable magnification optical system, Conditional Expression (5) represented by

$$0.1 < DAB / Y max < 1.5 \qquad ( 5 )$$

is satisfied.

According to a fourth aspect of the present disclosure, in the imaging optical system according to the first aspect, in a case where a refractive index of the LA lens with respect to a d line is represented by NA, and
a refractive index of the LB lens with respect to a d line is represented by NB, Conditional Expression (6) represented by

$$1 < NA / NB < 1.3 \qquad ( 6 )$$

is satisfied.

According to a fifth aspect of the present disclosure, in the imaging optical system according to the first aspect, the LA lens and the LB lens are disposed in the second optical system.

According to a sixth aspect of the present disclosure, in the imaging optical system according to the first aspect, the LB lens is cemented to a lens disposed adjacent to the reduction side of the LB lens.

According to a seventh aspect of the present disclosure, in the imaging optical system according to the first aspect, in a case where a lens closest to the intermediate image on the optical axis is represented by an LM lens, the LM lens is a positive lens.

According to an eighth aspect of the present disclosure, in the imaging optical system according to the seventh aspect, the LM lens is disposed adjacent to the enlargement side of the longest lens spacing.

According to a ninth aspect of the present disclosure, in the imaging optical system according to the first aspect, a first optical path deflection member that bends the optical path is disposed in the longest lens spacing.

According to a tenth aspect of the present disclosure, in the imaging optical system according to the ninth aspect, in a case where a distance on the optical axis from the first optical path deflection member to a lens surface closest to the reduction side in the second optical system is represented by DR, a maximum image height on the reduction-side imaging plane is represented by Ymax, and each value of DR and Ymax is set at the wide angle end in a case where the imaging optical system is a variable magnification optical system, Conditional Expression (7) represented by

$$8 < DR / Y max < 26 \qquad ( 7 )$$

is satisfied.

According to an eleventh aspect of the present disclosure, in the imaging optical system according to the ninth aspect, a second optical path deflection member that bends the optical path is disposed in the first optical system.

According to a twelfth aspect of the present disclosure, in the imaging optical system according to the eleventh aspect, in a case where a distance on the optical axis from the first optical path deflection member to the second optical path deflection member is represented by DMr12, a maximum image height on the reduction-side imaging plane is represented by Ymax, and each value of DMr12 and Ymax is set at the wide angle end in a case where the imaging optical system is a variable magnification optical system, Conditional Expression (8) represented by

$$8 < DMr 12 / Y max < 30 \qquad ( 8 )$$

is satisfied.

According to a thirteenth aspect of the present disclosure, in the imaging optical system according to the first aspect, the imaging optical system is a variable magnification optical system, one lens group is defined as a group of which a spacing to an adjacent group in an optical axis direction changes during changing magnification, and the second optical system includes two or more lens groups that move during changing magnification.

According to a fourteenth aspect of the present disclosure, in the imaging optical system according to the thirteenth aspect, the number of lens groups that move during changing magnification in the second optical system is two.

According to a fifteenth aspect of the present disclosure, in the imaging optical system according to the thirteenth aspect, in a case where a focal length of a lens group where a movement amount from the wide angle end to a telephoto end during changing magnification is maximum is represented by fz, and a focal length of the imaging optical system at the wide angle end is represented by fw, Conditional Expression (9) represented by

$$10 < fz / \vert fw \vert < 30 \qquad ( 9 )$$

is satisfied.

According to a sixteenth aspect of the present disclosure, in the imaging optical system according to the first aspect, an enlargement-side lens surface of a lens closest to the enlargement side in the first optical system is an aspherical surface that has a concave surface facing the enlargement side in a paraxial region and has an inflection point where an uneven shape changes halfway from the optical axis toward a peripheral portion.

According to a seventeenth aspect of the present disclosure, in the imaging optical system according to the first aspect, a reduction-side lens surface of a lens closest to the enlargement side in the first optical system is an aspherical surface that has a convex surface facing the reduction side in a paraxial region and has an inflection point where an uneven shape changes halfway from the optical axis toward a peripheral portion.

According to an eighteenth aspect of the present disclosure, in the imaging optical system according to the first aspect, the reduction side is telecentric.

According to a nineteenth aspect of the present disclosure, there is provided a projection type display device comprising: the imaging optical system according to any one of the first to eighteenth aspects.

According to a twentieth aspect of the present disclosure, there is provided an imaging apparatus comprising the imaging optical system according to any one of the first to eighteenth aspects.

In the present specification, it should be noted that the terms “consisting of” and “consists of” mean that the lens may include not only the above-described components but also lenses substantially having no refractive powers (powers), optical elements, which are not lenses, such as a stop, a mask, a filter, a cover glass, a plane mirror, and a prism, and mechanism parts such as a lens flange, a lens barrel, an imaging element, and a camera shaking correction mechanism.

“Lens group” and “focusing group” in the present specification are not limited to a configuration consisting of a plurality of lenses, but may be a configuration consisting of only one lens.

A compound aspherical lens (in which a lens (for example, a spherical lens) and an aspherical film formed on the lens are integrally formed and function as one aspherical lens as a whole) is not regarded as a cemented lens, but the compound aspherical lens is regarded as one lens. Regarding a lens having an aspherical surface, a curvature radius, the sign of a refractive power, and a surface shape, those in a paraxial region are used unless otherwise specified. The sign of the curvature radius of a surface that is convex to the enlargement side is positive, and the sign of the curvature radius of a surface that is convex to the reduction side is negative.

Unless otherwise specified, the “distance on the optical axis” used in Conditional Expression is considered as a geometrical distance. The “focal length” used in a conditional expression is a paraxial focal length. The values used in the conditional expression are values that are obtained with respect to the d line.

“d line”, “C line”, “F line”, and “g line” described in the present specification are bright lines. A wavelength of the d line is 587.56 nanometers (nm). A wavelength of the C line is 656.27 nanometers (nm). A wavelength of the F line is 486.13 nanometers (nm). A wavelength of the g line is 435.84 nanometers (nm).

According to the present disclosure, it is possible to provide a high-resolution imaging optical system where an angle of view is wide and various aberrations are appropriately corrected, a projection type display device including the imaging optical system, and an imaging apparatus including the imaging optical system.

### BRIEF DESCRIPTION OF THE DRAWINGS

FIG. 1 is a cross-sectional view showing a configuration and luminous fluxes of an imaging optical system according to an embodiment corresponding to an imaging optical system according to Example 1.

FIG. 2 is a diagram for describing symbols of conditional expressions.

FIG. 3 is a cross-sectional view illustrating an example of an imaging optical system where a first optical path deflection member and a second optical path deflection member are disposed.

FIG. 4 is a cross-sectional view illustrating another example of an imaging optical system where the first optical path deflection member and the second optical path deflection member are disposed.

FIG. 5 shows a spherical aberration diagram, an astigmatism diagram, a distortion diagram, and a lateral chromatic aberration diagram of the imaging optical system according to Example 1.

FIG. 6 is a lateral aberration diagram of the imaging optical system according to Example 1.

FIG. 7 is a cross-sectional view showing a configuration and luminous fluxes of an imaging optical system according to Example 2.

FIG. 8 shows a spherical aberration diagram, an astigmatism diagram, a distortion diagram, and a lateral chromatic aberration diagram of the imaging optical system according to Example 2.

FIG. 9 is a lateral aberration diagram of the imaging optical system according to Example 2.

FIG. 10 is a cross-sectional view showing a configuration and luminous fluxes of an imaging optical system according to Example 3.

FIG. 11 shows a spherical aberration diagram, an astigmatism diagram, a distortion diagram, and a lateral chromatic aberration diagram of the imaging optical system according to Example 3.

FIG. 12 is a lateral aberration diagram of the imaging optical system according to Example 3.

FIG. 13 is a cross-sectional view showing a configuration and luminous fluxes of an imaging optical system according to Example 4.

FIG. 14 shows a spherical aberration diagram, an astigmatism diagram, a distortion diagram, and a lateral chromatic aberration diagram of the imaging optical system according to Example 4.

FIG. 15 is a lateral aberration diagram of the imaging optical system according to Example 4.

FIG. 16 is a cross-sectional view showing a configuration and luminous fluxes of an imaging optical system according to Example 5.

FIG. 17 shows a spherical aberration diagram, an astigmatism diagram, a distortion diagram, and a lateral chromatic aberration diagram of the imaging optical system according to Example 5.

FIG. 18 is a lateral aberration diagram of the imaging optical system according to Example 5.

FIG. 19 is a cross-sectional view showing a configuration and luminous fluxes of an imaging optical system according to Example 6.

FIG. 20 shows a spherical aberration diagram, an astigmatism diagram, a distortion diagram, and a lateral chromatic aberration diagram of the imaging optical system according to Example 6.

FIG. 21 is a lateral aberration diagram of the imaging optical system according to Example 6.

FIG. 22 is a cross-sectional view showing a configuration and luminous fluxes of an imaging optical system according to Example 7.

FIG. 23 shows a spherical aberration diagram, an astigmatism diagram, a distortion diagram, and a lateral chromatic aberration diagram of the imaging optical system according to Example 7.

FIG. 24 is a lateral aberration diagram of the imaging optical system according to Example 7.

FIG. 25 is a schematic configuration diagram showing a projection type display device according to an embodiment.

FIG. 26 is a schematic configuration diagram showing a projection type display device according to another embodiment.

FIG. 27 is a schematic configuration diagram showing a projection type display device according to still another embodiment.

FIG. 28 is a schematic configuration diagram showing a projection type display device according to still another embodiment.

FIG. 29 is a perspective view showing a front side of an imaging apparatus according to an embodiment.

FIG. 30 is a perspective view showing a rear side of the imaging apparatus shown in FIG. 29.

### DETAILED DESCRIPTION

Hereinafter, an embodiment of the present disclosure will be described with reference to the drawings.

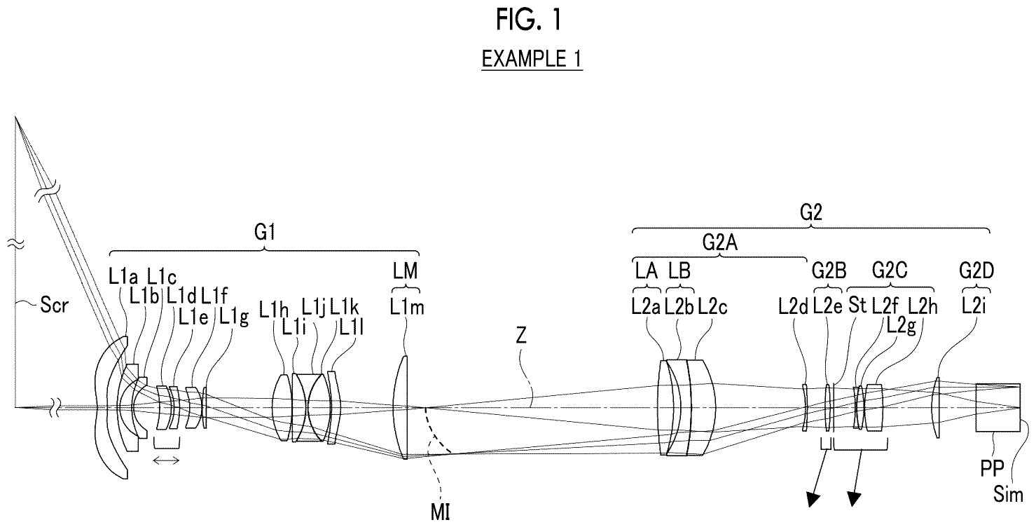

FIG. 1 shows a cross-sectional view showing a configuration and luminous fluxes of an imaging optical system according to an embodiment of the present disclosure. FIG. 1 shows, as the luminous fluxes, on-axis luminous fluxes and luminous fluxes with a maximum half angle of view. In FIG. 1, the left side is an enlargement side, and the right side is a reduction side. The example shown in FIG. 1 corresponds to an imaging optical system according to Example 1 described below.

The imaging optical system according to the present disclosure may be a projection optical system that is mounted on a projection type display device and forms an image to be projected onto a screen, or may be an imaging optical system that is mounted on an imaging apparatus and forms an image of an object. Hereinafter, the description will be made assuming a case where the imaging optical system is used for the projection optical system. In addition, in the following description, in order to avoid redundant description, “the imaging optical system of the present disclosure” will also be simply referred to as “the imaging optical system”.

FIG. 1 shows an example in which an optical member PP and a display surface Sim of a light valve are disposed on a reduction side of the imaging optical system on the assumption that the imaging optical system is mounted on a projection type display device. The light valve is a display element that outputs an optical image, and the optical image is displayed as an image on the display surface Sim. As the light valve, for example, a liquid crystal display element or an image display element such as digital micromirror device (DMD: registered trademark) can be used. The optical member PP is a member which is regarded as a filter, a cover glass, a color synthesis prism, or the like. The optical member PP is a member that has no refractive power. The material, the length, and the number of components of the optical member PP can be appropriately changed. A configuration in which the optical member PP is not provided can also be adopted.

In the projection type display device, a luminous flux provided with image information on the display surface Sim is incident into the imaging optical system through the optical member PP, and is projected onto a screen Scr through the imaging optical system. In this case, the display surface Sim corresponds to a reduction-side imaging plane, and the screen Scr corresponds to an enlargement-side imaging plane. It should be noted that, in the present specification, “the screen Scr” refers to an object on which a projected image formed by the imaging optical system is projected. The screen Ser may be not only a dedicated screen but also a wall surface of a room, a floor surface, a ceiling, an outer wall surface of a building, or the like.

In addition, in the description of the present specification, “the enlargement side” refers to the screen Scr side on the optical path, and “the reduction side” refers to the display surface Sim side on the optical path. In the present specification, “the enlargement side” and “the reduction side” are determined along the optical path, and this point also applies to an imaging optical system having a bent optical path. “Closest to the enlargement side” represents that a position is closest to the enlargement side in the arrangement order on the optical path, and does not represent that the position is closest to the screen Ser in terms of distance. Further, the term “adjacent” in the disposition of the components means that the components are adjacent to each other in the arrangement order on the optical path. Hereinafter, in order to avoid redundant description, “along the optical path in order from the enlargement side to the reduction side” will also be referred to as “in order from the enlargement side to the reduction side”.

The imaging optical system according to the present disclosure consists of a first optical system G1 and a second optical system G2 along the optical path in order from the enlargement side to the reduction side. The imaging optical system according to the present disclosure forms an intermediate image MI at a position conjugate to a reduction-side imaging plane and re-forms the intermediate image MI on an enlargement-side imaging plane. The position where the intermediate image MI is formed is between the first optical system G1 and the second optical system G2. “The position where the intermediate image MI is formed” described above refers to an imaging position of the intermediate image MI on the optical axis without being outside the optical axis.

That is, the imaging optical system according to the present disclosure is a relay optical system where the second optical system G2 is a relay group. In a case where the imaging optical system according to the present disclosure is applied as a projection optical system, the second optical system G2 forms the intermediate image MI of an image on the display surface, and the first optical system G1 enlarges and re-forms the intermediate image MI on the screen Ser as a projected image. In a case where the focal length of the imaging optical system is shortened to increase the angle of view, in order to achieve optical performance necessary for the imaging optical system while ensuring the back focus necessary for the imaging optical system, the size of the lens on the enlargement side tends to be increased. By using the relay optical system where the intermediate image MI is formed, irrespective of an ultra-wide-angle optical system, a compact configuration can be achieved while suppressing an increase in the diameter of the lens on the enlargement side. In FIG. 1, the intermediate image MI is schematically indicated by a broken line. The shape of the intermediate image MI in FIG. 1 does not need to be accurate. The method of showing the intermediate image MI is the same in the other drawings.

For example, each of the optical systems in FIG. 1 is configured as follows. The first optical system G1 consists of lenses L1a to Lim in order from the enlargement side to the reduction side. The second optical system G2 consists of a second A lens group G2A, a second B lens group G2B, a second C lens group G2C, and a second D lens group G2D along the optical path in order from the enlargement side to the reduction side. The second A lens group G2A consists of lenses L2a to L2d in order from the enlargement side to the reduction side. The second B lens group G2B consists of a lens L2e. The second C lens group G2C consists of an aperture stop St and lenses L2f to L2h in order from the enlargement side to the reduction side. The second D lens group G2D consists of a lens L2i. The aperture stop St shown in FIG. 1 does not show the size or the shape thereof, but shows a position thereof in the optical axis direction. The method of showing the aperture stop St is the same in the other drawings.

In addition, the imaging optical system according to the present disclosure may be a fixed focal point optical system or a variable magnification optical system. For example, the imaging optical system of FIG. 1 is a zoom lens. FIG. 1 shows a state at a wide angle end. In the example of FIG. 1, during changing magnification from the wide angle end to the telephoto end, the second B lens group G2B and the second C lens group G2C move along an optical axis Z while changing a mutual spacing, and all of the other lenses are fixed to the display surface Sim. Arrows below the second B lens group G2B and the second C lens group G2C of FIG. 1 indicate schematic moving directions of the respective lens groups during changing magnification from the wide angle end to the telephoto end.

In the present specification, in the second optical system G2, one lens group is a group of which a spacing to an adjacent group in the optical axis direction changes during changing magnification. That is, “lens group” is a component part of the second optical system G2, and is a part including at least one lens divided by an air spacing that changes during changing magnification. During changing magnification, a spacing between adjacent lenses does not change in one lens group. During changing magnification, the lens group units move or are fixed independently of each other. “Lens group” may include components having no power other than the lenses, for example, the aperture stop St and/or a plane mirror.

In a case where the imaging optical system according to the present disclosure is a variable magnification optical system, it is preferable that the second optical system G2 includes two or more lens groups that move during changing magnification. By imparting the change magnification action to the second optical system G2 that is the relay group, the simplification of the lens configuration is facilitated. In a case where the number of lens groups that move during changing magnification in the second optical system G2 is two, by limiting the number of lens groups that move to two, the simplification of the lens configuration is facilitated.

In general, among the lenses in the relay group, the diameters of lenses on the enlargement side and the reduction side are likely to increase. Accordingly, as in the example of FIG. 1, during changing magnification, the second A lens group G2A on the enlargement side and the second D lens group G2D on the reduction side are fixed, and the second B lens group G2B and the second C lens group G2C move such that the size of a mechanical mechanism for movement can be reduced. In addition, by fixing the second D lens group G2D during changing magnification, a variation in telecentricity during changing magnification can be suppressed.

In the present specification, a longest spacing among spacings on an optical axis between lenses in the imaging optical system will be referred to as “longest lens spacing”. In a case where the imaging optical system is a variable magnification optical system, the longest lens spacing is a value at the wide angle end. That is, in a case where the imaging optical system is a variable magnification optical system, which spacing is the longest lens spacing is determined depending on the state of the wide angle end. In addition, a spacing between lenses can be the longest lens spacing, and a spacing between a lens and an element (for example, a prism or a mirror) other than a lens is not the longest lens spacing.

In the present specification, a lens disposed adjacent to the reduction side of the longest lens spacing will be referred to as “LA lens LA”. In addition, a lens disposed adjacent to the reduction side of the LA lens LA will be referred to as “LB lens LB”. That is, the longest lens spacing, the LA lens LA, and the LB lens LB are continuously positioned in order from the enlargement side to the reduction side. In the example of FIG. 1, a spacing on the optical axis between the lens L1m and the lens L2a corresponds to the longest lens spacing, the lens L2a corresponds to the LA lens LA, and the lens L2b corresponds to the LB lens LB.

It is preferable that the LA lens LA and the LB lens LB are disposed in the second optical system G2. In this case, this configuration is advantageous in efficiently correcting coma aberration of a peripheral portion of an image.

It is preferable that the LB lens LB is cemented to a lens disposed adjacent to the reduction side of the LB lens LB to configure a cemented lens. In this case, this configuration is advantageous in correcting coma aberration of each color.

In the present specification, a lens closest to the intermediate image MI on the optical axis will be referred to as “LM lens LM”. In the example of FIG. 1, the lens L1m corresponds to the LM lens LM.

It is preferable that the LM lens LM is a positive lens. By disposing the positive lens at the position closest to the intermediate image MI on the optical axis, this positive lens can effectively function as a field lens, which can efficiently bend a ray of a peripheral portion of an image. As a result, this configuration is advantageous in reducing the size of a lens closer to the enlargement side than the LM lens LM.

It is preferable that the LM lens LM is disposed adjacent to the enlargement side of the longest lens spacing. On the reduction side of the LM lens LM that functions as the field lens, the diameter of the lens tends to increase. By providing the longest lens spacing adjacent to the reduction side of the LM lens LM, a configuration where the number of lenses having a large diameter is suppressed can be adopted.

It is preferable that an enlargement-side lens surface of a lens closest to the enlargement side in the first optical system G1 is an aspherical surface that has a concave surface facing the enlargement side in a paraxial region and has an inflection point where an uneven shape changes halfway from the optical axis toward a peripheral portion. In this case, distortion can be suppressed while ensuring a wide angle of view. In the present specification, “lens surface” refers to a surface through which a ray used for imaging transmits among the surfaces of a lens.

It is preferable that a reduction-side lens surface of a lens closest to the enlargement side in the first optical system G1 is an aspherical surface that has a convex surface facing the reduction side in a paraxial region and has an inflection point where an uneven shape changes halfway from the optical axis toward a peripheral portion. In this case, distortion can be suppressed while ensuring a wide angle of view.

In addition, the inflection point is a point where the surface shape switches from a convex shape to a concave shape or a point where the surface shape switches from a concave shape to a convex shape that is, a point where the sign of the curvature radius changes. The lens surface has the inflection point such that the refractive power of the peripheral portion of the lens can be determined without depending on the refractive power of the paraxial region.

In the imaging optical system according to the present disclosure, it is preferable that the reduction side is telecentric. In a projection type display device that outputs a high-definition image, a three-plate system is adopted, and favorable telecentricity is required. In addition, in recent years, in order to achieve a small-sized high-definition projection type display device, a so-called pixel shift system in which a resolution of 2 times or 4 times the number of pixels of the display element is achieved by shifting the pixels has been increased. In order to ensure the resolution at this time, it is desirable to use a telecentric optical system.

In the present specification, “the reduction side being telecentric” refers to a state a line bisecting an angle between the upper maximum ray and the lower maximum ray is parallel or substantially parallel to the optical axis Z in a cross section of a luminous flux that is focused on any point of the display surface Sim of the reduction side. That is, the meaning of “the reduction side being telecentric” in the present specification includes a state where there are some errors without being limited to a completely telecentric state, that is, a state where the line bisecting the angle is completely parallel to the optical axis Z. Here, the state where there are some errors refers to a state where an inclination of the line bisecting the angle with respect to the optical axis Z is in a range of −3 degrees or more and +3 degrees or less. In a case where the imaging optical system includes an aperture stop, a principal ray that is a ray passing through the center of the aperture stop may be used instead of the line bisecting the angle to determine the telecentricity.

In the imaging optical system according to the present disclosure, it is preferable that distortion is suppressed within a range of −3% or more and +3% or less. Further, it is preferable that the imaging optical system has a maximum total angle of view of 120 degrees or more. In a case where the imaging optical system is a variable magnification optical system, it is preferable that the maximum total angle of view at the wide angle end is 120 degrees or more.

It is preferable that the imaging optical system according to the present disclosure does not include a reflection type element having a power. In the imaging optical system according to the present disclosure, it is preferable that all of the optical elements having a power are refraction type elements. In an imaging optical system including a reflection type optical element having a power, in general, a luminous flux near the optical axis reflected from a reflecting surface is shielded by the projection type display device and cannot be used for forming a projected image. Therefore, in order to avoid the light shielding, a center position of the image of the reduction-side imaging plane is configured to be shifted from the optical axis Z of the imaging optical system, and the amount of shift is usually increased. Therefore, in the imaging optical system including a reflection type optical element having a power, the size of the reflecting surface having a power tends to be large, and thus it is difficult to achieve reduction in size thereof. In contrast, in the imaging optical system where all of the optical elements having a power are refraction type elements, the luminous flux near the optical axis can be used for forming the projected image, and thus the amount of shift can be reduced even in a case where the shift is performed. By reducing the amount of shift, each optical element can be reduced in size. Therefore, the entire optical system can be led to reduction in size.

The imaging optical system according to the present disclosure is preferably a coaxial system. In this case, the optical system can be configured more simply as compared to a case where the optical system is a non-coaxial system.

The imaging optical system according to the present disclosure may be configured to include a focus group that performs focusing by moving in a case where a projection distance changes. For example, in the example of FIG. 1, the focus group consists of lenses L1d to L1e. In FIG. 1, a parenthesis and a two-way arrow parallel to the optical axis Z are shown below the lenses corresponding to the focus group. In the drawings of the present application, a plurality of lenses shown in one parenthesis attached to an arrow indicating movement move integrally. “Move integrally” represents moving at the same time in the same direction by the same amount.

The imaging optical system according to the present disclosure may be configured to include a mount portion that is attachable to and detachable from a mount portion in a projection type display device. In this case, the attachment and detachment of the imaging optical system is easy, which is convenient in replacing or maintaining the imaging optical system.

Next, preferable and possible configurations about conditional expressions of the imaging optical system according to the present disclosure will be described. In the following description relating to the conditional expressions, in order to avoid redundant description, factors having the same definition will be represented by the same symbols, and the description thereof will not be repeated. In addition, hereinafter, “the imaging optical system according to the present disclosure” will also be simply referred to as the “the imaging optical system” in order to avoid redundant description. In a case where the imaging optical system is a variable magnification optical system, symbols in the following conditional expressions are values at the wide angle end.

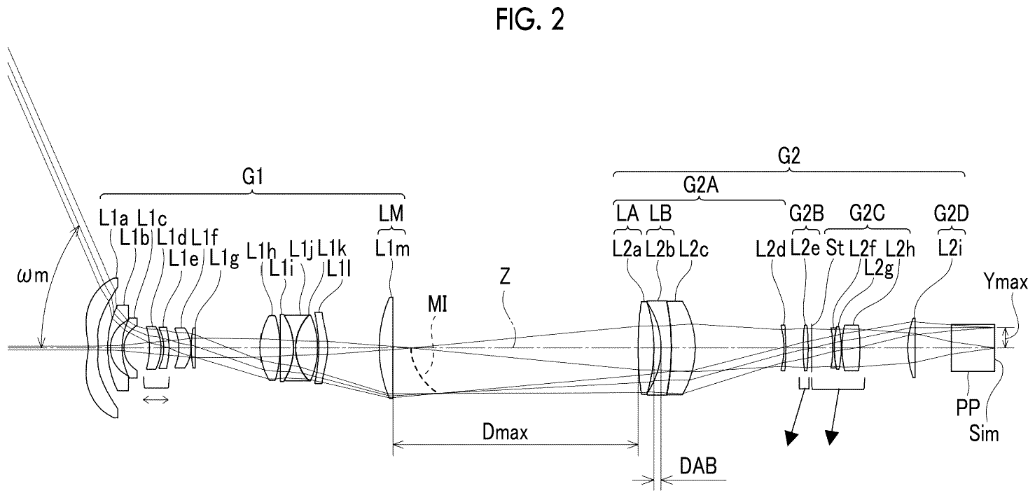

It is preferable that, in a case where a maximum half angle of view of the enlargement side is represented by om, the imaging optical system satisfies Conditional Expression (1). tan of Conditional Expression (1) is a tangent. FIG. 2 shows a configuration of luminous fluxes of the imaging optical system of FIG. 1, and shows, for example, the above-described maximum half angle of view ωm. The corresponding value of Conditional Expression (1) is set not to be the lower limit value or less, which is advantageous in ensuring the required angle of view. By setting the corresponding value of Conditional Expression (1) not to be the upper limit value or more, an increase in the size of the optical system can be suppressed.

$$1.73 < tan ω m < 5 \qquad ( 1 )$$

In order to obtain more favorable characteristics, the lower limit value of Conditional Expression (1) is more preferably 1.8, still more preferably 2, and still more preferably 2.1. In order to obtain more favorable characteristics, the upper limit value of Conditional Expression (1) is more preferably 4, still more preferably 3, and still more preferably 2.6. For example, it is more preferable that the imaging optical system satisfies at least one of Conditional Expression (1-1), (1-2), or (1-3).

$$1.8 < tan ω m < 4 \qquad ( 1 - 1 )$$

$$2 < tan ω m < 3 \qquad ( 1 - 2 )$$

$$2.1 < tan ω m < 2.6 \qquad ( 1 - 3 )$$

It is preferable that the imaging optical system satisfies Conditional Expression (2). Here, a curvature radius of an enlargement-side surface of the LA lens LA is represented by RAf. A curvature radius of a reduction-side surface of the LA lens LA is represented by RAr. By satisfying Conditional Expression (2), refractive power arrangement on the enlargement-side surface and the reduction-side surface of the LA lens LA is favorable, which is advantageous in favorably correcting spherical aberration.

$$0 < ( RAf + RAr ) / ( RAf - RAr ) < 1.5 \qquad ( 2 )$$

In order to obtain more favorable characteristics, the lower limit value of Conditional Expression (2) is more preferably 0.1, still more preferably 0.2, and still more preferably 0.3. In order to obtain more favorable characteristics, the upper limit value of Conditional Expression (2) is more preferably 1, still more preferably 0.8, and still more preferably 0.7. For example, it is more preferable that the imaging optical system satisfies at least one of Conditional Expression (2-1), (2-2), or (2-3).

$$0.1 < ( RAf + RAr ) / ( RAf - RAr ) < 1 \qquad ( 2 - 1 )$$

$$0.2 < ( RAf + RAr ) / ( RAf - RAr ) < 0.8 \qquad ( 2 - 2 )$$

$$0.3 < ( RAf + RAr ) / ( RAf - RAr ) < 0.7 \qquad ( 2 - 3 )$$

It is preferable that the imaging optical system satisfies Conditional Expression (3). Here, a curvature radius of an enlargement-side surface of the LB lens LB is represented by RBf. Assuming that an air spacing between the reduction-side surface of the LA lens LA and the enlargement-side surface of the LB lens LB is an air lens, Conditional Expression (3) is an expression that defines an appropriate range of a form factor of the air lens. By satisfying Conditional Expression (3), this configuration is advantageous in appropriately correcting coma aberration and field curvature.

$$1 < ( RAr + RBf ) / ( RAr - RBf ) < 10 \qquad ( 3 )$$

In order to obtain more favorable characteristics, the lower limit value of Conditional Expression (3) is more preferably 1.5, still more preferably 2, and still more preferably 2.5. In order to obtain more favorable characteristics, the upper limit value of Conditional Expression (3) is more preferably 5, still more preferably 4.5, and still more preferably 4. For example, it is more preferable that the imaging optical system satisfies at least one of Conditional Expression (3-1), (3-2), or (3-3).

$$1.5 < ( RAr + RBf ) / ( RAr - RBf ) < 5 \qquad ( 3 - 1 )$$

$$2 < ( RAr + RBf ) / ( RAr - RBf ) < 4.5 \qquad ( 3 - 2 )$$

$$2.5 < ( RAr + RBf ) / ( RAr - RBf ) < 4 \qquad ( 3 - 3 )$$

It is more preferable that the imaging optical system simultaneously satisfies Conditional Expressions (1), (2), and (3). The imaging optical system simultaneously satisfies Conditional Expressions (1), (2), and (3) such that it is easy to realize a high-resolution optical system where an angle of view is wide, the number of lenses is suppressed, and various aberrations are appropriately corrected.

It is preferable that the imaging optical system satisfies Conditional Expression (4). Here, an air conversion distance of the longest lens spacing is represented by Dmax. A focal length of the imaging optical system is represented by f. For example, FIG. 2 shows the air conversion distance Dmax of the longest lens spacing. By setting the corresponding value of Conditional Expression (4) not to be the lower limit value or less, this configuration is advantageous in correcting various aberrations while suppressing the number of lenses. In addition, in a case where Conditional Expressions (2) and (3) are satisfied and the corresponding value of Conditional Expression (4) is not the lower limit value or less, this configuration is more advantageous in correcting various aberrations while suppressing the number of lenses. By setting the corresponding value of Conditional Expression (4) not to be the upper limit value or more, this configuration is advantageous in reducing the total length of the lens system, and thus an increase in the size of the optical system can be suppressed.

$$10 < D max / \vert f \vert < 45 \qquad ( 4 )$$

In order to obtain more favorable characteristics, the lower limit value of Conditional Expression (4) is more preferably 12, still more preferably 14, and still more preferably 15. In order to obtain more favorable characteristics, the upper limit value of Conditional Expression (4) is more preferably 40, still more preferably 35, and still more preferably 32. For example, it is more preferable that the imaging optical system satisfies at least one of Conditional Expression (4-1), (4-2), or (4-3).

$$12 < Dmax / \vert f \vert < 40 \qquad ( 4 - 1 )$$

$$14 < D max / \vert f \vert < 35 \qquad ( 4 - 2 )$$

$$15 < D max / \vert f \vert < 32 \qquad ( 4 - 3 )$$

It is preferable that the imaging optical system satisfies Conditional Expression (5). Here, a distance on the optical axis between the LA lens LA and the LB lens LB is represented by DAB. A maximum image height on the reduction-side imaging plane is represented by Ymax. For example, FIG. 2 shows the distance DAB and the maximum image height Ymax. By setting the corresponding value of Conditional Expression (5) not to be the lower limit value or less, the distance DAB is not excessively small, which is advantageous in ensuring the degree of freedom of the curvatures on the reduction-side surface of the LA lens LA and the enlargement-side surface of the LB lens LB. By setting the corresponding value of Conditional Expression (5) not to be the upper limit value or more, the distance DAB is not excessively large. Therefore, the air spacing between the reduction-side surface of the LA lens LA and the enlargement-side surface of the LB lens LB can be assumed as an air lens. By satisfying Conditional Expression (5), this configuration is advantageous in appropriately exhibiting the effect of Conditional Expression (3).

$$0.1 < DAB / Y max < 1.5 \qquad ( 5 )$$

In order to obtain more favorable characteristics, the lower limit value of Conditional Expression (5) is more preferably 0.15, still more preferably 0.2, and still more preferably 0.22. In order to obtain more favorable characteristics, the upper limit value of Conditional Expression (5) is more preferably 1.2, still more preferably 0.9, and still more preferably 0.6. For example, it is more preferable that the imaging optical system satisfies at least one of Conditional Expression (5-1), (5-2), or (5-3).

$$0.15 < DAB / Y max < 1.2 \qquad ( 5 - 1 )$$

$$0.2 < DAB / Y max < 0.9 \qquad ( 5 - 2 )$$

$$0.22 < DAB / Y max < 0. 6 \qquad ( 5 - 3 )$$

It is preferable that the imaging optical system satisfies Conditional Expression (6). Here, a refractive index of the LA lens LA with respect to the d line is represented by NA. A refractive index of the LB lens LB with respect to the d line is represented by NB. By setting the corresponding value of Conditional Expression (6) not to be the lower limit value or less, it is easy to suitably maintain a balance between the refractive power of the reduction-side surface of the reduction-side surface of the LA lens LA and the refractive power of the enlargement-side surface of the LB lens LB, and thus the amount of coma aberration can be suppressed. By setting the corresponding value of Conditional Expression (6) not to be the upper limit value or more, the refractive index of the LB lens LB is not excessively low, which is advantageous in maintaining favorable optical performance of a peripheral portion of an image, in particular, in favorably correcting astigmatism.

$$1 < NA / NB < 1.3 \qquad ( 6 )$$

In order to obtain more favorable characteristics, the lower limit value of Conditional Expression (6) is more preferably 1.05, still more preferably 1.08, and still more preferably 1.1. In order to obtain more favorable characteristics, the upper limit value of Conditional Expression (6) is more preferably 1.25, still more preferably 1.2, and still more preferably 1.15. For example, it is more preferable that the imaging optical system satisfies at least one of Conditional Expression (6-1), (6-2), or (6-3).

$$1.05 < NA / NB < 1 \text{.25} \qquad ( 6 - 1 )$$

$$1.08 < NA / NB < 1.2 \qquad ( 6 - 2 )$$

$$1.1 < NA / NB < 1. 15 \qquad ( 6 - 3 )$$

In the configuration where the imaging optical system is a variable magnification optical system and the second optical system G2 includes two or more lens groups that move during changing magnification, it is preferable that the imaging optical system satisfies Conditional Expression (9). Here, a focal length of a lens group where a movement amount from the wide angle end to the telephoto end during changing magnification is maximum is represented by fz. A focal length of the imaging optical system at the wide angle end is represented by fw. By setting the corresponding value of Conditional Expression (9) not to be the lower limit value or less, the refractive power of the lens group where the movement amount from the wide angle end to the telephoto end during changing magnification is maximum is not excessively strong, which is advantageous in suppressing variations in spherical aberration during changing magnification. By setting the corresponding value of Conditional Expression (9) not to be the upper limit value or more, the refractive power of the lens group where the movement amount from the wide angle end to the telephoto end during changing magnification is maximum is not excessively weak. Therefore, the movement amount during changing magnification can be suppressed, which is advantageous in reducing the size of the entire optical system.

$$10 < fz / \vert fw \vert < 30 \qquad ( 9 )$$

In order to obtain more favorable characteristics, the lower limit value of Conditional Expression (9) is more preferably 13, still more preferably 15, and still more preferably 17. In order to obtain more favorable characteristics, the upper limit value of Conditional Expression (9) is more preferably 28, still more preferably 26, and still more preferably 25. For example, it is more preferable that the imaging optical system satisfies at least one of Conditional Expression (9-1), (9-2), or (9-3).

$$13 < fz / \vert fw \vert < 28 \qquad ( 9 - 1 )$$

$$15 < fz / \vert fw \vert < 26 \qquad ( 9 - 2 )$$

$$17 < fz / \vert fw \vert < 25 \qquad ( 9 - 3 )$$

It is preferable that the imaging optical system satisfies Conditional Expression (10). Here, in a case where the reduction side is a back side, a back focus of the imaging optical system in terms of an air conversion distance is represented by Bf. By satisfying Conditional Expression (10), a back focus having an appropriate length can be ensured. It is more preferable that the imaging optical system satisfies Conditional Expression (10-1). By setting the corresponding value of Conditional Expression (10-1) not to be the upper limit value or more, an increase in the size of the optical system can be suppressed.

$$Bf / \vert f \vert > 5 \qquad ( 10 )$$

$$5 < Bf / \vert f \vert < 20 \qquad ( 10 - 1 )$$

In the imaging optical system according to the present disclosure, a first optical path deflection member that bends the optical path may be disposed in the longest lens spacing. By bending the optical path, a compact configuration can be adopted, which is advantageous in reducing the size.

In addition, in the imaging optical system according to the present disclosure, a second optical path deflection member that bends the optical path may be disposed in the first optical system G1. By bending the optical path, a compact configuration can be adopted, which is advantageous in reducing the size.

In the imaging optical system according to the present disclosure, the first optical path deflection member that bends the optical path may be disposed in the longest lens spacing, and the second optical path deflection member that bends the optical path may be disposed in the first optical system G1. The imaging optical system includes the two members that bend the optical path. As a result, as compared to a case where the imaging optical system includes only one member that bends the optical path, a more compact configuration can be adopted, which is advantageous in further reducing the size. In addition, in the configuration where the bending portion is rotatable, the lens closest to the enlargement side can be positioned in any direction, and thus an image can be projected in various directions while fixing the projection type display device main body.

As the first optical path deflection member and the second optical path deflection member, for example, a prism or a mirror having a reflecting surface can be used. An angle at which the first optical path deflection member and the second optical path deflection member bend the optical path can be freely set and may be, for example, 90 degrees. By setting the angle at which the optical path is bent to 90 degrees, a structure that is easily produced can be adopted. It should be noted that “the 90 degrees” includes an error that is practically allowed in the technical field to which the present disclosed technology belongs. The error may be, for example, in a range of −5 degrees or more and +5 degrees or less. In a case where the imaging optical system is a variable magnification optical system, in order to simplify the device, it is preferable that the first optical path deflection member and the second optical path deflection member are fixed during changing magnification.

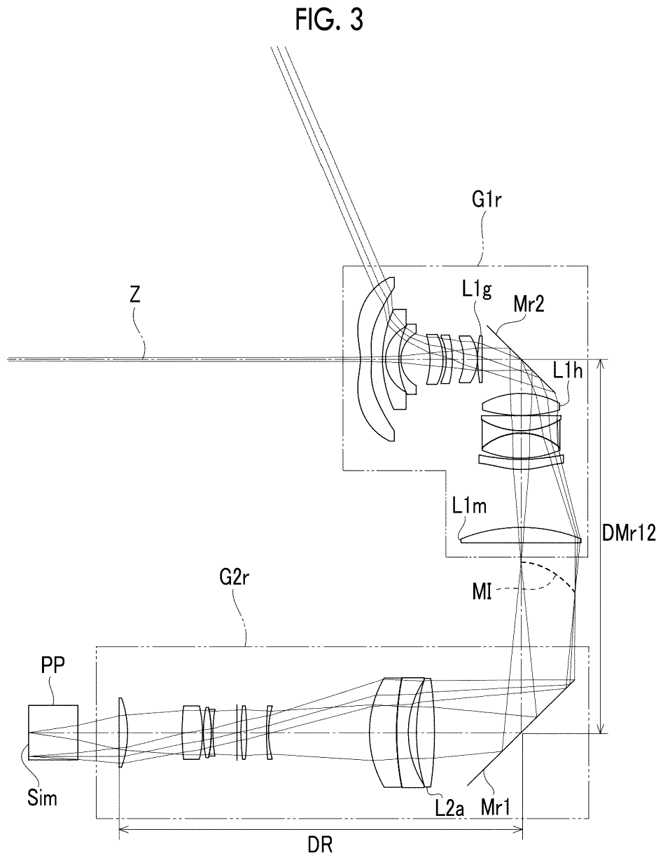

For example, FIG. 3 shows a configuration example where the first optical path deflection member and the second optical path deflection member are disposed in the imaging optical system of FIG. 1. FIG. 3 shows the configuration at the wide angle end, and some of the reference numerals of the lenses are not shown to avoid the drawing from being complicated.

The imaging optical system of FIG. 3 consists of a first optical system G1r and a second optical system G2r along the optical path in order from the enlargement side to the reduction side. The first optical system G1r of the imaging optical system of FIG. 3 is different from the first optical system G1 of the imaging optical system of FIG. 1, in that a mirror Mr2 is disposed between a lens L1g and a lens L1h and the optical path is bent by the mirror Mr2, and the configurations of the other lenses are the same. The second optical system G2r of the imaging optical system of FIG. 3 is different from the second optical system G2 of the imaging optical system of FIG. 1, in that a mirror Mr1 is disposed on the enlargement side of the lens L2a and the optical path is bent by the mirror Mr1, and the configurations of the other lenses are the same. The mirror Mr1 corresponds to the first optical path deflection member, and the mirror Mr2 corresponds to the second optical path deflection member.

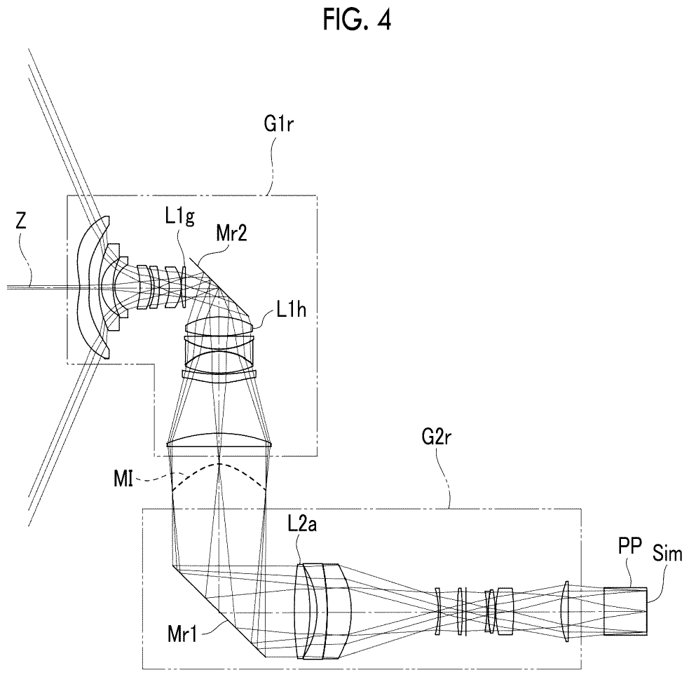

FIG. 4 shows another configuration example where the first optical path deflection member and the second optical path deflection member are disposed in the imaging optical system of FIG. 1. The imaging optical system of FIG. 4 consists of a first optical system G1r and a second optical system G2r along the optical path in order from the enlargement side to the reduction side. The imaging optical system of FIG. 4 is different from the imaging optical system of FIG. 3 in a direction in which the optical path is bent, and the other configurations are the same. In the example of FIG. 3, an extension line of the mirror Mr1 and an extension line of the mirror Mr2 are disposed to intersect each other, and the entire optical path of the imaging optical system has a schematic shape obtained by rotating a “U” shape counterclockwise by 90 degrees. On the other hand, in the example of FIG. 4, the mirror Mr1 and the mirror Mr2 are disposed parallel to each other, and the entire optical path of the imaging optical system has a substantially “Z” shape. Note that, in the present disclosed technology, the method of bending the optical path is not limited to the example of FIGS. 3 and 4, and the optical path may be bent at an intermediate angle between the example of FIG. 3 and the example of FIG. 4, or the angle at which the optical path is bent can be freely set in a possible range.

In the configuration where the first optical path deflection member that bends the optical path is disposed in the longest lens spacing, it is preferable that the imaging optical system satisfies Conditional Expression (7). Here, a distance on the optical axis from the first optical path deflection member to a lens surface closest to the reduction side in the second optical system G2r is represented by DR. For example, FIG. 3 shows the distance DR. By setting the corresponding value of Conditional Expression (7) not to be the lower limit value or less, a length required for avoiding interference with an optical engine can be ensured. By setting the corresponding value of Conditional Expression (7) not to be the upper limit value or more, an increase in the size of the optical system can be suppressed.

$$8 < DR / Y max < 26 \qquad ( 7 )$$

In order to obtain more favorable characteristics, the lower limit value of Conditional Expression (7) is more preferably 11, still more preferably 12, and still more preferably 13. In order to obtain more favorable characteristics, the upper limit value of Conditional Expression (7) is more preferably 24, still more preferably 22, and still more preferably 20. For example, it is more preferable that the imaging optical system satisfies at least one of Conditional Expression (7-1), (7-2), or (7-3).

$$11 < DR / Y max < 24 \qquad ( 7 - 1 )$$

$$12 < DR / Y max < 22 \qquad ( 7 - 2 )$$

$$13 < DR / Y max < 20 \qquad ( 7 - 3 )$$

In the configuration where the first optical path deflection member that bends the optical path is disposed in the longest lens spacing and the second optical path deflection member that bends the optical path is disposed in the first optical system, it is preferable that the imaging optical system satisfies Conditional Expression (8). Here, a distance on the optical axis from the first optical path deflection member to the second optical path deflection member is represented by DMr12. For example, FIG. 3 shows the distance DMr12. In a case where it is desired that the projection type display device is inconspicuous in spatial presentation or the like, an image can be projected in a state where only some of lenses are exposed while hiding the projection type display device main body. By setting the corresponding value of Conditional Expression (8) not to be the lower limit value or less, an image can be projected in the above-described state, which can contribute to improvement of general-purpose properties of the projection type display device. In addition, in the configuration example shown FIG. 3, by setting the corresponding value of Conditional Expression (8) not to be the lower limit value or less, a length required for avoiding interference with an optical engine can be ensured. By setting the corresponding value of Conditional Expression (8) not to be the upper limit value or more, an increase in the size of the optical system can be suppressed.

$$8 < DMr 12 / Y max < 30 \qquad ( 8 )$$

In order to obtain more favorable characteristics, the lower limit value of Conditional Expression (8) is more preferably 9, still more preferably 9.5, and still more preferably 10. In order to obtain more favorable characteristics, the upper limit value of Conditional Expression (8) is more preferably 25, still more preferably 20, and still more preferably 18. For example, it is more preferable that the imaging optical system satisfies at least one of Conditional Expression (8-1), (8-2), or (8-3).

$$9 < DMr 12 / Y max < 25 \qquad ( 8 - 1 )$$

$$9.5 < DMr 12 / Y max < 20 \qquad ( 8 - 2 )$$

$$10 < DMr 12 / Y max < 18 \qquad ( 8 - 3 )$$

The preferable configurations and available configurations including the configurations regarding the conditional expressions can be freely combined within a range where they do not contradict each other, and it is preferable to appropriately selectively adopt the combination according to required specifications. Various modifications can be made without departing from the scope of the present disclosed technology. For example, in the present disclosed technology, the number of lenses in each of the optical systems, the number of lens groups in the second optical system, the number of lenses in each of lens groups, and the number of lenses in the focus group in the focus group may be different from those of the example of FIG. 1. The lens groups that are fixed and the lens groups that move during changing magnification, and the focus group may be different from those of the example of FIG. 1.

For example, one preferable aspect of the imaging optical system according to the present disclosure is an imaging optical system that forms an intermediate image at a position conjugate to a reduction-side imaging plane and re-forms the intermediate image on an enlargement-side imaging plane, the imaging optical system consisting of a first optical system G1 and a second optical system G2 along an optical path in order from an enlargement side to a reduction side, in which the intermediate image MI is formed between the first optical system G1 and the second optical system G2, a LA lens LA is disposed adjacent to the reduction side of a longest lens spacing that is a longest spacing among spacings on an optical axis between lenses in the imaging optical system, a LB lens LB is disposed adjacent to the reduction side of the LA lens LA, and Conditional Expressions (1), (2), and (3) are satisfied.

Next, examples of the imaging optical system of the present disclosure will be described, with reference to the drawings. It should be noted that the reference numerals attached to the lenses, the lens groups, and the optical systems in the cross-sectional views of each example are used independently for each example in order to avoid complication of description and drawings caused by an increase in number of digits of the reference numerals. Therefore, even in a case where common reference numerals are added in the drawings of different examples, components do not necessarily have a common configuration.

### Example 1

FIG. 1 is a cross-sectional view of a configuration and luminous fluxes of an imaging optical system of Example 1, and an illustration method and a configuration thereof are as described above. Therefore, some description is not repeated herein. The imaging optical system according to Example 1 is a variable magnification optical system, and consists of the first optical system G1 and the second optical system G2 in order from the enlargement side to the reduction side. The intermediate image MI is formed between the first optical system G1 and the second optical system G2. The second optical system G2 consists of a second A lens group G2A, a second B lens group G2B, a second C lens group G2C, and a second D lens group G2D along the optical path in order from the enlargement side to the reduction side. During changing magnification from the wide angle end to the telephoto end, the second B lens group G2B and the second C lens group G2C move along an optical axis Z while changing a mutual spacing, and all of the other lenses are fixed to the display surface Sim.

Regarding the imaging optical system according to Example 1, Tables 1A and 1B show basic lens data, Table 2 shows specifications and variable surface spacings during changing magnification, and Table 3 shows aspherical coefficients. Here, the basic lens data is shown to be divided into two tables including Tables 1A and 1B, in order to avoid an increase in length of one table. The table of basic lens data also shows the optical member PP. FIG. 1 is a diagram showing a linear optical path, and the table of the basic lens data shows data including the first optical path deflection member and the second optical path deflection member in consideration of a case where the first optical path deflection member and the second optical path deflection member are disposed in the imaging optical system.

The table of the basic lens data is described as follows. The “Sn” column shows surface numbers in a case where the surface closest to the enlargement side is the first surface and the number is increased one by one toward the reduction side. Note that “Mr1” is shown in the field of the surface number of the surface corresponding to the first optical path deflection member, and “Mr2” is shown in the field of the surface number of the surface corresponding to the second optical path deflection member. Further, the surface number and “(St)” are shown in the field of the surface number of the surface corresponding to the aperture stop St. The surface closest to the reduction side in the table corresponds to the display surface Sim. The R column shows a curvature radius of each surface. The sign of the curvature radius of a surface that is convex to the enlargement side is positive, and the sign of the curvature radius of a surface that is convex to the reduction side is negative. The D column shows a surface spacing between each surface and the surface adjacent to the reduction side on the optical axis. The symbol DD[ ] is used for the variable surface spacing during changing magnification, and the surface number of the enlargement-side surface of the spacing is given in [ ] and is shown in the field D. The Nd column shows a refractive index of each component with respect to the d line. The νd column shows an Abbe number of each component with respect to the d line. The ED column shows a maximum effective diameter of each surface. On the left side of the “Sn” column, the rows of the lenses corresponding to the LM lens LM, the LA lens LA, and the LB lens LB are labeled with “LM”, “LA”, and “LB”, respectively.

Table 2 shows a zoom ratio, an absolute value of the focal length, a back focus Bf in terms of the air conversion distance (in Table 2, shown as “Back Focus”), an open F-number, a maximum total angle of view, and a variable surface spacing during changing magnification with respect to the d line. The back focus in terms of the air conversion distance is an air conversion distance from the lens surface closest to the reduction side in the imaging optical system to the display surface Sim. In the field of the maximum total angle of view, [°] indicates that the unit is degrees. In Table 2, the values in the wide angle end state, the middle focal length state, and the telephoto end state are respectively shown in the columns labeled with “WIDE”, “MIDDLE”, and “TELE”.

In the basic lens data, a reference sign * is added to surface numbers of aspherical surfaces, and values of paraxial curvature radius are shown in the fields of the curvature radius of the aspherical surface. In Table 3, the row of Sn shows surface numbers of the aspherical surfaces, and the rows of KA and Am (m=3, 4, 5, 6, . . . , 20) show numerical values of the aspherical coefficients for each aspherical surface. The “E±n” (n: an integer) in the numerical values of the aspherical coefficients of Table 3 indicates “×10^{±n}”. KA and Am represent the aspherical coefficients in an aspheric equation represented by the following expression.

$$Zd = C \times {h}^{2} / \{ 1 + {( 1 - KA \times {C}^{2} \times {h}^{2} )}^{1 / 2} \} + Σ A m \times {h}^{m}$$

where
Zd is an aspherical surface depth (a length of a perpendicular from a point on an aspherical surface at a height h to a plane that is perpendicular to the optical axis Z and in contact with the aspherical surface apex),
h is a height (a distance from the optical axis Z to the lens surface),
C is a reciprocal of the paraxial curvature radius,
KA and Am are aspherical coefficients, and
Σ in the aspheric equation represents the total sum regarding m.

The following tables and aberration diagrams described below are data in a case where the maximum image height on the reduction-side imaging plane is normalized to 10. In addition, each of the following tables shows numerical values rounded off to predetermined decimal places.

TABLE 1A
Example 1

| | Sn | R | D | Nd | νd | ED |
|---|---|---|---|---|---|---|
| | *1 | −22.9651 | 4.5804 | 1.50922 | 56.47 | 66.78 |
| | *2 | −60.4066 | 4.5385 | | | 56.49 |
| | 3 | 49.7650 | 1.2587 | 1.91082 | 35.25 | 40.08 |
| | 4 | 15.4337 | 5.4895 | | | 27.15 |
| | 5 | 33.4630 | 0.8741 | 1.72916 | 54.67 | 26.78 |
| | 6 | 12.7936 | 12.0341 | | | 21.46 |
| | 7 | −36.9804 | 5.3776 | 1.77250 | 49.62 | 19.09 |
| | 8 | −23.4124 | 1.3287 | | | 19.16 |
| | 9 | −22.3436 | 2.5035 | 1.80610 | 33.27 | 17.97 |
| | 10 | −43.5762 | 4.6776 | | | 18.06 |
| | 11 | −23.1970 | 5.6713 | 1.48749 | 70.44 | 16.94 |
| | 12 | −17.8855 | 0.1119 | | | 17.65 |
| | 13 | 56.8231 | 1.9021 | 1.86966 | 20.02 | 16.79 |
| | 14 | ∞ | 16.0839 | | | 16.43 |
| | Mr2 | ∞ | 14.3077 | | | |
| | 15 | 32.6880 | 9.2168 | 1.49700 | 81.61 | 30.85 |
| | 16 | −57.2408 | 0.1399 | | | 30.68 |
| | 17 | ∞ | 6.2168 | 1.48749 | 70.44 | 29.86 |
| | 18 | −31.2971 | 0.0350 | | | 29.45 |
| | 19 | −31.0737 | 1.0140 | 1.84666 | 23.84 | 29.44 |
| | 20 | 23.9935 | 10.2797 | 1.49700 | 81.61 | 30.27 |
| | 21 | −40.8839 | 0.6014 | | | 31.26 |
| | *22 | −57.5975 | 4.1958 | 1.51633 | 64.06 | 32.11 |
| | *23 | −30.2109 | 24.2517 | | | 33.46 |
| LM | 24 | 65.9700 | 6.4755 | 1.80518 | 25.46 | 49.33 |
| | 25 | ∞ | 79.6014 | | | 49.16 |

TABLE 1B
Example 1

| | Sn | R | D | Nd | νd | ED |
|---|---|---|---|---|---|---|
| | Mr1 | ∞ | 35.8042 | | | |
| LA | 26 | 164.9242 | 7.4685 | 1.80420 | 46.50 | 43.75 |
| | 27 | −78.5897 | 3.3636 | | | 43.39 |
| LB | 28 | −40.5539 | 4.8462 | 1.62004 | 36.26 | 43.26 |
| | 29 | −121.3448 | 11.2378 | 1.65160 | 58.54 | 44.06 |
| | 30 | −46.1608 | 41.4965 | | | 44.76 |
| | 31 | −40.8689 | 0.8392 | 1.77250 | 49.62 | 20.94 |
| | 32 | −144.3475 | DD[32] | | | 20.98 |
| | 33 | 100.9027 | 2.3497 | 1.60738 | 56.82 | 20.96 |
| | 34 | −100.9027 | DD[34] | | | 20.86 |
| | 35(St) | ∞ | 9.9441 | | | 18.99 |
| | 36 | −57.0660 | 0.6643 | 1.85451 | 25.15 | 18.55 |
| | 37 | 48.2162 | 0.0657 | | | 18.84 |
| | 38 | 51.5440 | 3.2308 | 1.49700 | 81.61 | 18.85 |
| | 39 | −51.5440 | 0.3636 | | | 19.23 |
| | 40 | 48.5726 | 8.4476 | 1.49700 | 81.61 | 20.10 |
| | 41 | −98.7400 | DD[41] | | | 20.84 |
| | 42 | 43.5686 | 3.4895 | 1.86966 | 20.02 | 27.48 |
| | 43 | ∞ | 17.0607 | | | 27.32 |
| | 44 | ∞ | 20.3497 | 1.51680 | 64.20 | |
| | 45 | ∞ | | | | |

TABLE 2
Example 1

| | WIDE | MIDDLE | TELE |
|---|---|---|---|
| Zoom Ratio | 1.00 | 1.04 | 1.09 |
| \|Focal Length\| | 4.20 | 4.35 | 4.58 |
| Back Focus | 30.45 | 30.45 | 30.45 |
| Open F-Number | 2.21 | 2.22 | 2.24 |
| Maximum Total Angle of | 134.6 | 133.2 | 131.0 |
| View [°] | | | |
| DD[32] | 8.1949 | 5.3930 | 1.2188 |
| DD[34] | 1.6759 | 3.9046 | 6.7888 |
| DD[41] | 22.5475 | 23.1207 | 24.4107 |

TABLE 3
Example 1

| Sn | 1 | 2 | 22 | 23 |
|---|---|---|---|---|
| KA | 3.1093178E−01 | −2.5949932E+01 | 1.0000000E+00 | 1.0000000E+00 |
| A3 | −3.9407771E−04 | 5.9262966E−05 | 0.0000000E+00 | 0.0000000E+00 |
| A4 | 3.4694544E−04 | 1.7207644E−04 | −1.4706028E−04 | −5.3663395E−05 |
| A5 | −2.2985347E−05 | −6.0922066E−06 | 1.0624300E−04 | 4.9803764E−05 |
| A6 | −1.3860182E−07 | −6.8690729E−07 | −3.0175685E−05 | −1.1551905E−05 |
| A7 | 8.4544809E−08 | 4.5846736E−08 | 4.6434347E−06 | 1.3616990E−06 |
| A8 | −2.6541340E−09 | 7.4641944E−10 | −3.6935076E−07 | −6.9684014E−08 |
| A9 | −1.2161884E−10 | −1.1700743E−10 | 4.5350468E−09 | −1.9178498E−09 |
| A10 | 8.4419594E−12 | 1.1941297E−13 | 1.9126588E−09 | 4.9225166E−10 |
| A11 | 7.8053909E−15 | 1.8563534E−13 | −1.5879727E−10 | −2.4741861E−11 |
| A12 | −1.1219192E−14 | −1.2795249E−15 | 1.2839411E−12 | −2.5390992E−13 |
| A13 | 1.7415240E−16 | −2.1634957E−16 | 4.8142283E−13 | 8.1303974E−14 |
| A14 | 7.1132801E−18 | 2.0235307E−18 | −2.3448661E−14 | −2.6712825E−15 |
| A15 | −2.0353473E−19 | 1.8957936E−19 | −2.3165375E−16 | −5.9750124E−17 |
| A16 | −1.6023407E−21 | −2.3354774E−21 | 4.6497055E−17 | 5.3235453E−18 |
| A17 | 9.6140938E−23 | −1.0397091E−22 | −8.8781574E−19 | −5.5725403E−20 |
| A18 | −3.1453528E−25 | 1.6406563E−24 | −2.2704249E−20 | −2.7519867E−21 |
| A19 | −1.6952491E−26 | 2.5137530E−26 | 9.6686941E−22 | 6.5799838E−23 |
| A20 | 1.5083279E−28 | −4.7529587E−28 | −8.5722922E−24 | −2.4263473E−25 |

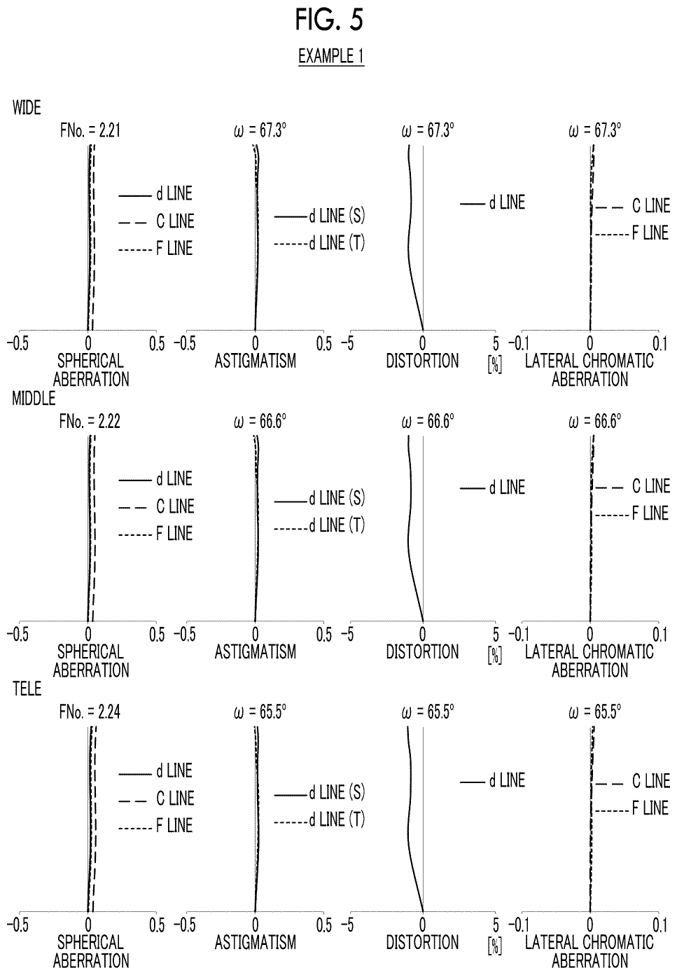

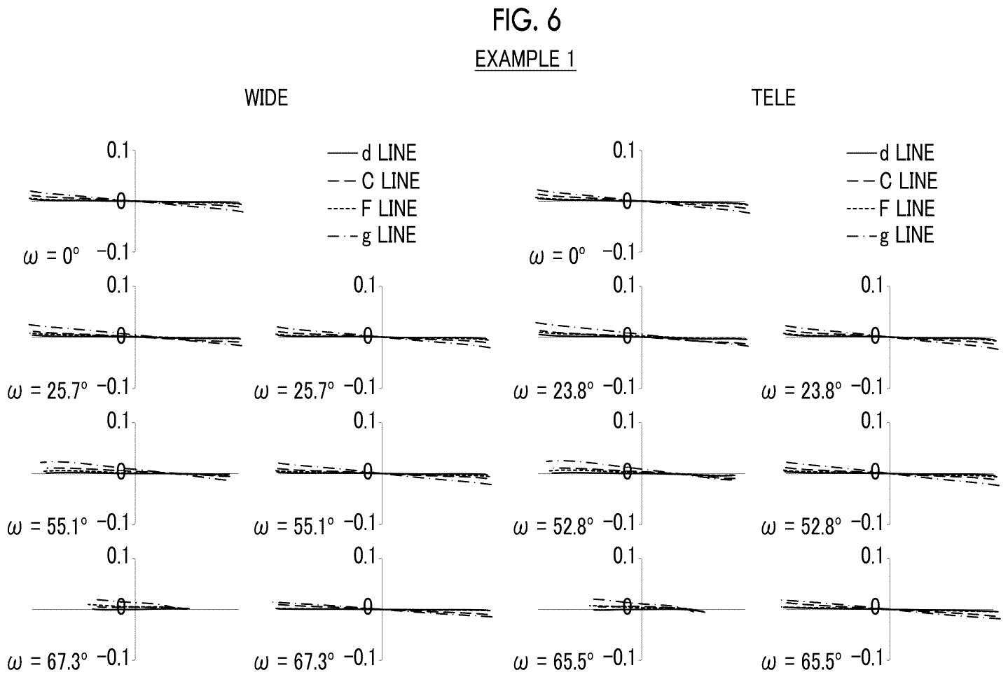

FIGS. 5 and 6 show each of aberration diagrams in a state where the projection distance is 771.3. In FIG. 5, the upper part labeled “WIDE” shows aberrations in the wide angle end state, the middle part labeled “MIDDLE” shows aberrations in the middle focal length state, and the lower part labeled “TELE” shows aberrations in the telephoto end state. FIG. 5 shows spherical aberration, astigmatism, distortion, and lateral chromatic aberration in order from the left side. In the spherical aberration diagram, aberrations regarding the d line, the C line, and the F line are indicated by a solid line, a long broken line, and a short broken line, respectively. In the astigmatism diagram, an aberration regarding the d line in the sagittal direction is indicated by a solid line, and an aberration regarding the d line in the tangential direction is indicated by a short broken line. In the distortion diagram, an aberration regarding the d line is indicated by a solid line. In the lateral chromatic aberration diagram, aberrations regarding the C line and the F line are indicated by a long broken line and a short broken line, respectively. In the spherical aberration diagram, a value of the open F-number in each state is shown after “FNo.=”. In other aberration diagrams of FIG. 5, the value of the maximum half angle of view in each state is shown after “ω=”.

In FIG. 6, the left part labeled “WIDE” shows aberrations at the wide angle end state, and the right part labeled “TELE” shows lateral aberration at the telephoto end state. Among the diagrams of “WIDE”, four diagrams of the left column show aberrations in a tangential direction, and three diagrams of the right column show aberrations in a sagittal direction. In FIG. 6, the value of the maximum half angle of view is shown after “@=”, and lateral aberration at each angle of view is shown. The aberrations with respect to the d line, the C line, the F line, and the g line are indicated by a solid line, a long broken line, a short broken line, and a dot-dashed line, respectively. The same applies to the diagrams of “TELE”.

Symbols, meanings, description methods, illustration methods of the respective data pieces according to Example 1, and the point that the maximum image height on the reduction-side imaging plane is normalized to 10 are basically the same as those in the following examples unless otherwise specified. Therefore, hereinafter, repeated description will not be given. It should be noted that in the cross-sectional view of the following examples, the screen Scr is not shown.

### Example 2

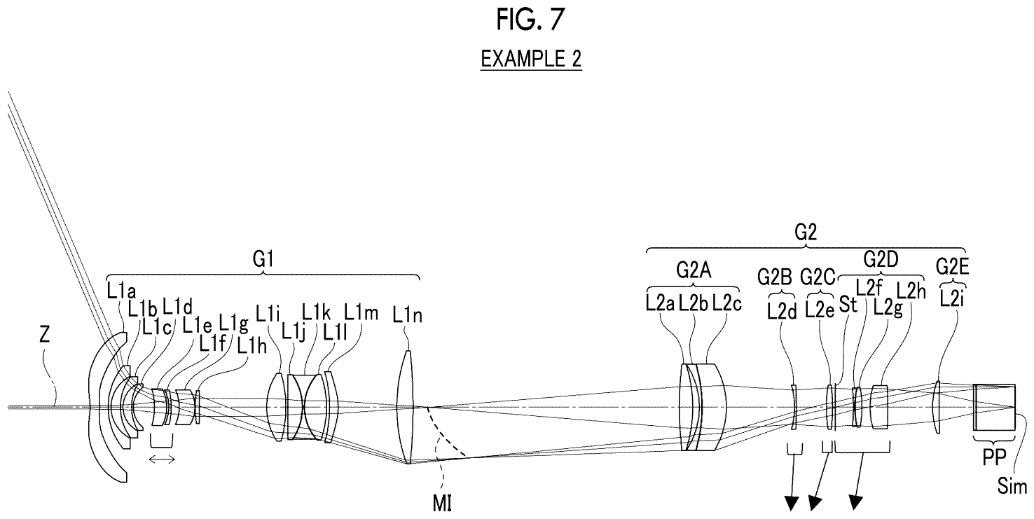

FIG. 7 shows a cross-sectional view of a configuration and luminous fluxes of an imaging optical system according to Example 2. The imaging optical system according to Example 2 is a variable magnification optical system, and consists of the first optical system G1 and the second optical system G2 in order from the enlargement side to the reduction side. The intermediate image MI is formed between the first optical system G1 and the second optical system G2. The second optical system G2 consists of a second A lens group G2A, a second B lens group G2B, a second C lens group G2C, a second D lens group G2D, and a second E lens group G2E along the optical path in order from the enlargement side to the reduction side. During changing magnification from the wide angle end to the telephoto end, the second B lens group G2B, the second C lens group G2C, and the second D lens group G2D move along an optical axis Z while changing a spacing with a lens group adjacent thereto, and all of the other lenses are fixed to the display surface Sim.

The first optical system G1 consists of lenses L1a to Lin in order from the enlargement side to the reduction side. The second A lens group G2A consists of lenses L2a to L2c in order from the enlargement side to the reduction side. The second B lens group G2B consists of a lens L2d. The second C lens group G2C consists of a lens L2c. The second D lens group G2D consists of an aperture stop St and lenses L2f to L2h in order from the enlargement side to the reduction side. The second E lens group G2E consists of a lens L2i. The focus group consists of lenses L1e to L1f.

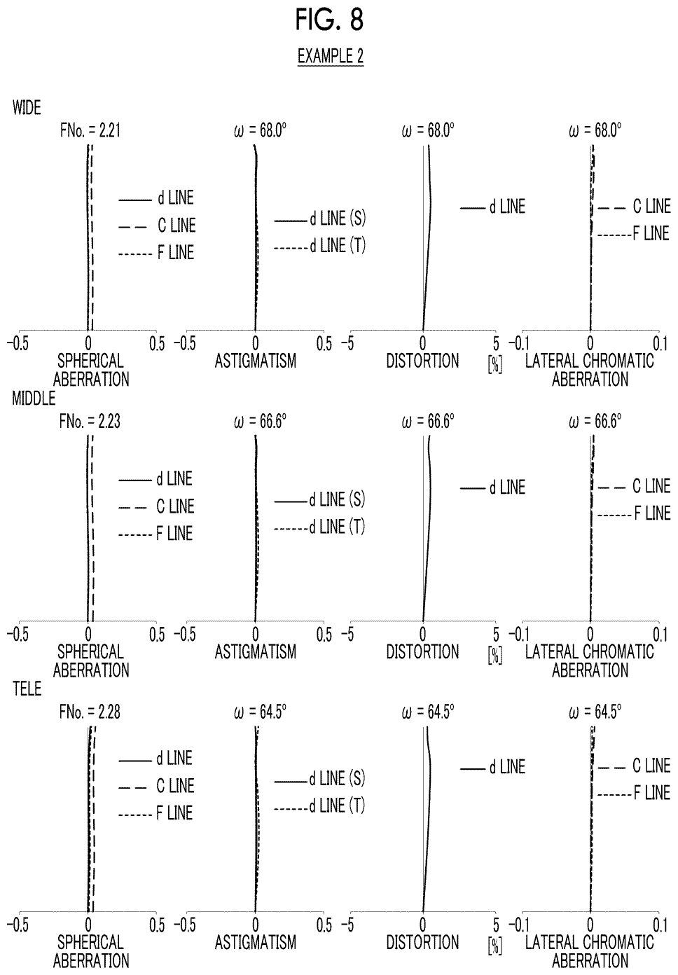

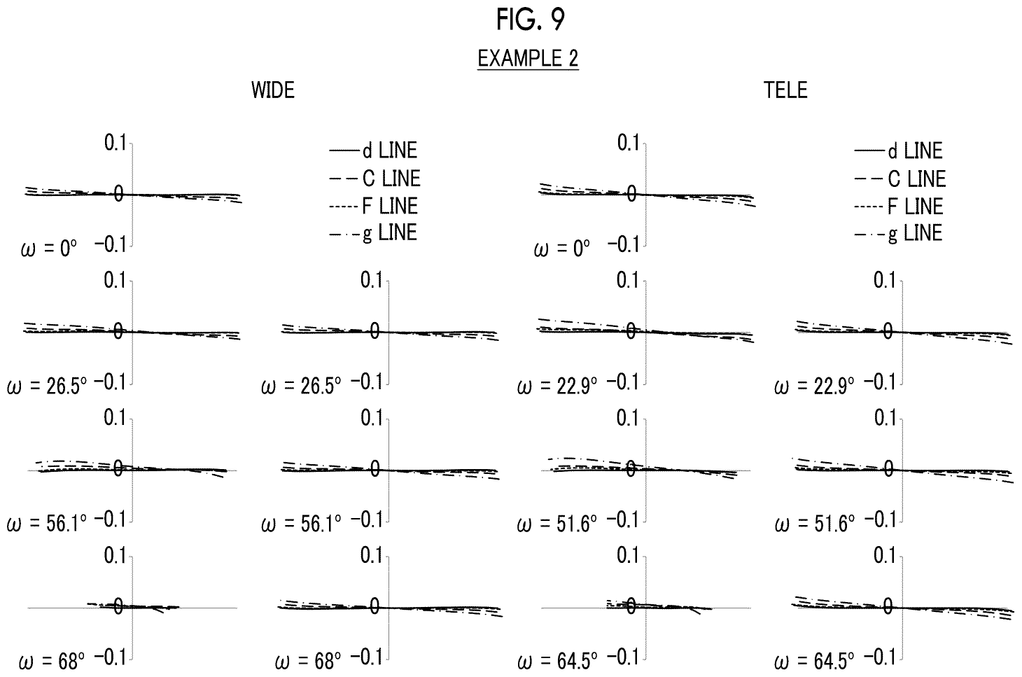

Regarding the imaging optical system according to Example 2, Tables 4A and 4B show basic lens data, Table 5 shows specifications and variable surface spacings during changing magnification, Table 6 shows aspherical coefficients, and FIGS. 8 and 9 show each of the aberration diagrams. The aberration diagrams are in a state where the projection distance is 753.3.

TABLE 4A
Example 2

| | Sn | R | D | Nd | νd | ED |
|---|---|---|---|---|---|---|
| | *1 | −23.7786 | 4.3327 | 1.50872 | 56.36 | 69.68 |
| | *2 | −54.8806 | 3.9997 | | | 57.49 |
| | 3 | 32.8744 | 1.3333 | 1.83481 | 42.72 | 40.96 |
| | 4 | 17.4365 | 4.3506 | | | 30.53 |
| | 5 | 25.6251 | 1.2000 | 1.90366 | 31.31 | 29.98 |
| | 6 | 13.2450 | 3.9674 | | | 23.22 |
| | 7 | 23.2665 | 0.8333 | 1.72916 | 54.54 | 23.05 |
| | 8 | 13.1416 | 9.8242 | | | 20.14 |
| | 9 | −33.8326 | 5.6673 | 1.72916 | 54.54 | 18.36 |
| | 10 | −20.8445 | 0.9466 | | | 18.62 |
| | 11 | −20.3057 | 1.1718 | 1.80610 | 33.27 | 17.78 |
| | 12 | −39.8781 | 3.6950 | | | 17.98 |
| | 13 | −21.9892 | 7.3337 | 1.48749 | 70.44 | 17.34 |
| | 14 | −17.2584 | 0.1061 | | | 18.39 |
| | 15 | 51.7330 | 1.9219 | 1.86966 | 20.02 | 17.16 |
| | 16 | 450.3950 | 12.6660 | | | 16.76 |
| | Mr2 | ∞ | 18.6394 | | | |
| | 17 | 31.5234 | 8.9511 | 1.49700 | 81.61 | 34.06 |
| | 18 | −61.6595 | 0.9011 | | | 33.89 |
| | 19 | −10005.2293 | 6.7593 | 1.48749 | 70.44 | 32.35 |
| | 20 | −29.4140 | 0.9667 | 1.84666 | 23.84 | 31.68 |
| | 21 | 24.9460 | 10.2606 | 1.49700 | 81.61 | 31.75 |
| | 22 | −48.8130 | 1.4134 | | | 32.51 |
| | *23 | −67.5530 | 3.9794 | 1.49710 | 81.56 | 33.27 |
| | *24 | −31.0298 | 27.2619 | | | 34.62 |
| LM | 25 | 86.3132 | 7.5593 | 1.84666 | 23.84 | 56.42 |
| | 26 | −282.8282 | 76.9764 | | | 56.40 |

TABLE 4B
Example 2

| | Sn | R | D | Nd | νd | ED |
|---|---|---|---|---|---|---|
| | Mr1 | ∞ | 46.4449 | | | |
| LA | 27 | 178.6951 | 6.2435 | 1.80420 | 46.50 | 42.47 |
| | 28 | −71.4724 | 3.0346 | | | 42.19 |
| LB | 29 | −40.0000 | 1.3339 | 1.62004 | 36.30 | 41.94 |
| | 30 | −77.9479 | 11.2818 | 1.58913 | 61.25 | 42.10 |
| | 31 | −43.2040 | DD[31] | | | 42.31 |
| | 32 | −40.5429 | 0.8002 | 1.72916 | 54.54 | 21.65 |
| | 33 | −254.0928 | DD[33] | | | 21.71 |
| | 34 | 71.6343 | 2.8830 | 1.48749 | 70.44 | 21.70 |
| | 35 | −93.8011 | DD[35] | | | 21.55 |
| | 36(St) | ∞ | 8.3804 | | | 18.60 |
| | 37 | −84.7790 | 0.6333 | 1.85451 | 25.15 | 18.89 |
| | 38 | 45.3078 | 0.1464 | | | 19.16 |
| | 39 | 52.3752 | 3.2033 | 1.49700 | 81.61 | 19.16 |
| | 40 | −53.1164 | 3.1752 | | | 19.57 |
| | 41 | 40.8764 | 8.1840 | 1.49700 | 81.61 | 21.21 |
| | 42 | −257.9238 | DD[42] | | | 21.20 |
| | 43 | 40.7778 | 3.0257 | 1.86966 | 20.02 | 25.48 |
| | 44 | 395.9086 | 9.0276 | | | |
| | 45 | ∞ | 1.3333 | 1.48749 | 70.44 | |
| | 46 | ∞ | 18.0667 | 1.51680 | 64.20 | |
| | 47 | ∞ | | | | |

TABLE 5
Example 2

| | WIDE | MIDDLE | TELE |
|---|---|---|---|
| Zoom Ratio | 1.00 | 1.07 | 1.18 |
| \|Focal Length\| | 4.00 | 4.28 | 4.72 |
| Back Focus | 28.69 | 28.69 | 28.69 |
| Open F-Number | 2.21 | 2.23 | 2.28 |
| Maximum Total Angle of | 136.0 | 133.2 | 129.0 |
| View [°] | | | |
| DD[31] | 31.6642 | 31.8354 | 32.0434 |
| DD[33] | 13.9655 | 8.5913 | 0.9500 |
| DD[35] | 1.3333 | 5.4317 | 10.3723 |
| DD[42] | 20.8521 | 21.9567 | 24.4494 |

TABLE 6
Example 2

| Sn | 1 | 2 | 23 | 24 |
|---|---|---|---|---|
| KA | 2.5945303E−01 | −2.0824747E+01 | 1.0000000E+00 | 1.0000000E+00 |
| A3 | 3.8611213E−04 | 5.2107843E−04 | 0.0000000E+00 | 0.0000000E+00 |
| A4 | 2.5617565E−04 | 1.7281075E−04 | −1.9499302E−04 | −1.3351369E−04 |
| A5 | −2.0657825E−05 | −9.4146473E−06 | 1.3365974E−04 | 9.1918429E−05 |
| A6 | 1.3593049E−07 | −7.2874774E−07 | −4.2472760E−05 | −2.5416878E−05 |
| A7 | 6.1257978E−08 | 6.7651660E−08 | 7.3767203E−06 | 3.7002717E−06 |
| A8 | −2.6254745E−09 | 3.5806062E−10 | −6.5069572E−07 | −2.3486043E−07 |
| A9 | −5.7032501E−11 | −1.7292734E−10 | 8.1288950E−09 | −7.2121683E−09 |
| A10 | 6.5625094E−12 | 2.2643456E−12 | 3.9972964E−09 | 2.2284133E−09 |
| A11 | −6.5865617E−14 | 2.3794770E−13 | −3.3889549E−10 | −1.1819265E−10 |
| A12 | −7.1261800E−15 | −5.4864472E−15 | 1.3610093E−12 | −2.5212365E−12 |
| A13 | 1.9388446E−16 | −1.8282589E−16 | 1.2304498E−12 | 5.2619377E−13 |
| A14 | 3.1960481E−18 | 5.5328433E−18 | −5.6477677E−14 | −1.5861803E−14 |
| A15 | −1.7426685E−19 | 7.9679120E−20 | −9.3309368E−16 | −5.3137982E−16 |
| A16 | 1.8826196E−22 | −2.9474862E−21 | 1.3470801E−16 | 4.4284366E−17 |
| A17 | 7.1045412E−23 | −1.7950522E−23 | −2.2902264E−18 | −6.1668715E−19 |
| A18 | −6.2979165E−25 | 8.0438221E−25 | −8.2063528E−20 | −2.5988227E−20 |
| A19 | −1.1129328E−26 | 1.6394253E−27 | 3.1666078E−21 | 1.0028388E−21 |
| A20 | 1.4906145E−28 | −8.9456067E−29 | −2.6373135E−23 | −1.0009414E−23 |

### Example 3

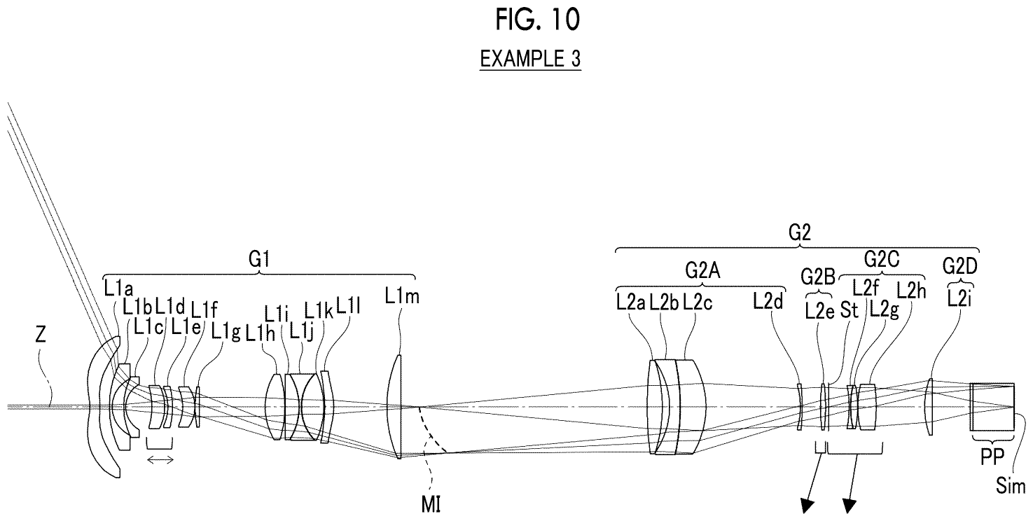

FIG. 10 shows a cross-sectional view of a configuration and luminous fluxes of an imaging optical system according to Example 3. The imaging optical system according to Example 3 is a variable magnification optical system, and consists of the first optical system G1 and the second optical system G2 in order from the enlargement side to the reduction side. The intermediate image MI is formed between the first optical system G1 and the second optical system G2. The second optical system G2 consists of a second A lens group G2A, a second B lens group G2B, a second C lens group G2C, and a second D lens group G2D along the optical path in order from the enlargement side to the reduction side. During changing magnification from the wide angle end to the telephoto end, the second B lens group G2B and the second C lens group G2C move along an optical axis Z while changing a mutual spacing, and all of the other lenses are fixed to the display surface Sim.

The first optical system G1 consists of lenses L1a to Lim in order from the enlargement side to the reduction side. The second A lens group G2A consists of lenses L2a G2B consists of a lens L2e. The second C lens group G2C consists of an aperture stop St and lenses L2f to L2h in order from the enlargement side to the reduction side. The second D lens group G2D consists of a lens L2i. The focus group consists of lenses L1d to L1e.

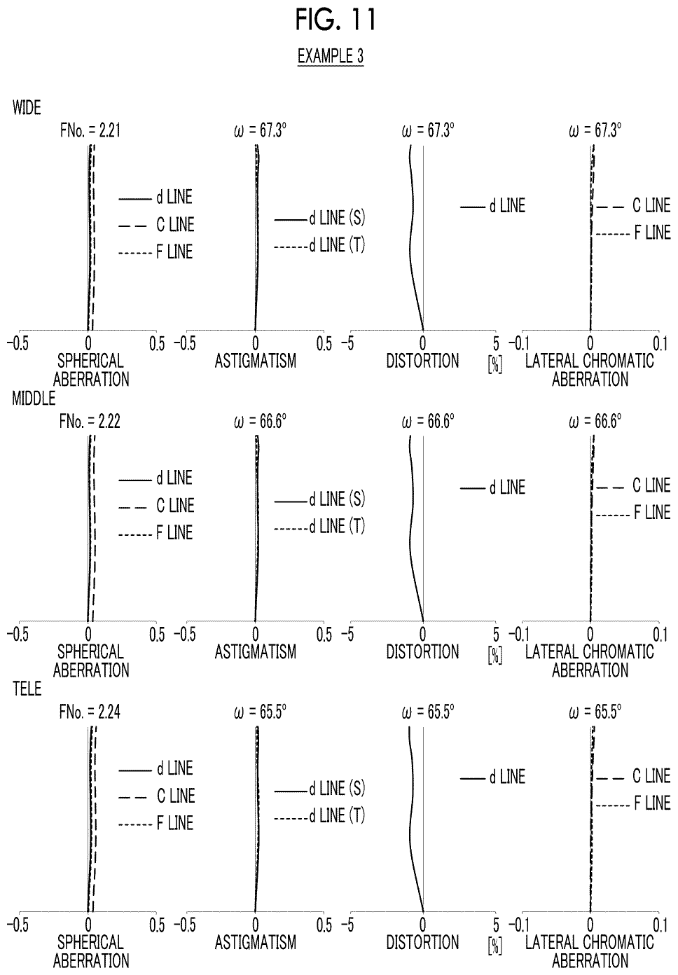

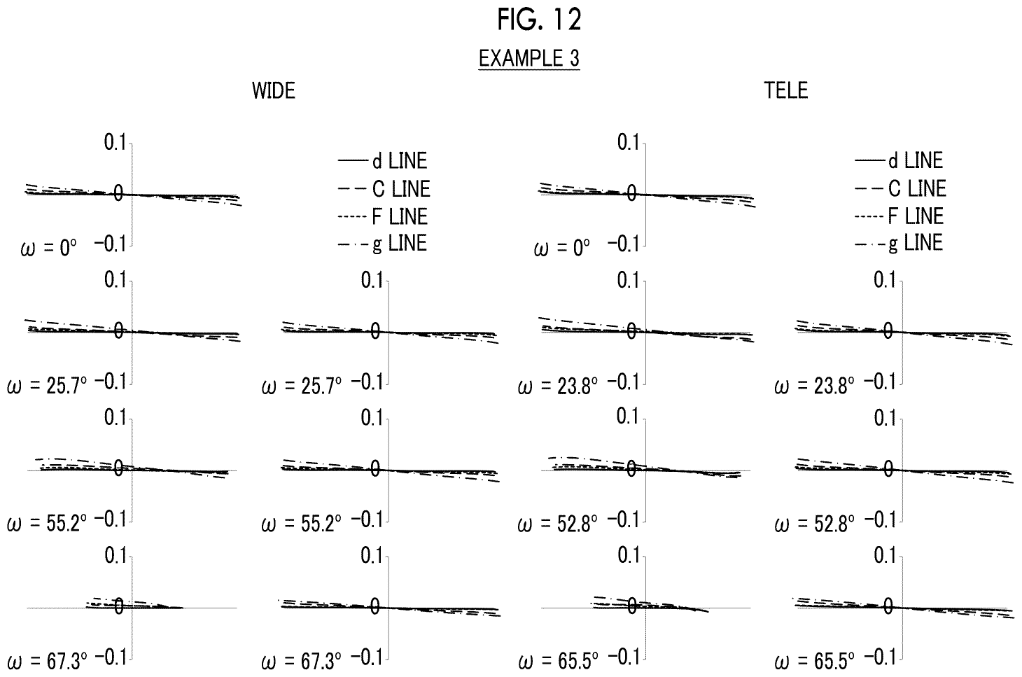

Regarding the imaging optical system according to Example 3, Tables 7A and 7B show basic lens data, Table 8 shows specifications and variable surface spacings during changing magnification, Table 9 shows aspherical coefficients, and FIGS. 11 and 12 show each of the aberration diagrams. The aberration diagrams are in a state where the projection distance is 790.2.

TABLE 7A
Example 3

| | Sn | R | D | Nd | νd | ED |
|---|---|---|---|---|---|---|
| | *1 | −23.3826 | 4.5803 | 1.53638 | 56.09 | 66.85 |
| | *2 | −58.7937 | 4.4027 | | | 56.68 |
| | 3 | 49.6739 | 1.2587 | 1.91082 | 35.25 | 40.08 |
| | 4 | 15.6409 | 5.3771 | | | 27.31 |
| | 5 | 34.6897 | 0.8741 | 1.72916 | 54.67 | 27.08 |
| | 6 | 12.8460 | 12.0738 | | | 21.58 |
| | 7 | −36.4377 | 5.9269 | 1.77250 | 49.62 | 19.18 |
| | 8 | −23.5927 | 1.4430 | | | 19.23 |
| | 9 | −22.4403 | 2.1644 | 1.80610 | 33.27 | 17.98 |
| | 10 | −43.0024 | 4.6848 | | | 18.21 |
| | 11 | −22.9356 | 5.6227 | 1.48749 | 70.44 | 17.20 |
| | 12 | −17.9579 | 0.1121 | | | 17.92 |
| | 13 | 56.5204 | 1.9206 | 1.86966 | 20.02 | 17.01 |
| | 14 | ∞ | 13.2868 | | | 16.64 |
| | Mr2 | ∞ | 17.1325 | | | |
| | 15 | 32.6718 | 9.0725 | 1.49700 | 81.61 | 30.86 |
| | 16 | −58.1400 | 0.1613 | | | 30.70 |
| | 17 | ∞ | 6.4518 | 1.48749 | 70.44 | 30.09 |
| | 18 | −31.2108 | 0.0347 | | | 29.60 |
| | 19 | −31.0006 | 1.0140 | 1.84666 | 23.84 | 29.60 |
| | 20 | 24.0889 | 10.2698 | 1.49700 | 81.61 | 30.32 |
| | 21 | −40.6936 | 0.5047 | | | 31.26 |
| | *22 | −57.9592 | 4.1957 | 1.51633 | 64.06 | 32.14 |
| | *23 | −30.3037 | 24.5273 | | | 33.46 |
| LM | 24 | 65.9633 | 6.4797 | 1.80518 | 25.46 | 49.33 |
| | 25 | ∞ | 76.5012 | | | 49.16 |

TABLE 7B
Example 3

| | Sn | R | D | Nd | νd | ED |
|---|---|---|---|---|---|---|
| | Mr1 | ∞ | 36.8604 | | | |
| LA | 26 | 183.9149 | 6.9713 | 1.80420 | 46.50 | 43.52 |
| | 27 | −76.3669 | 3.3609 | | | 43.23 |
| LB | 28 | −40.1188 | 4.9077 | 1.62004 | 36.26 | 43.07 |
| | 29 | −118.1256 | 11.8887 | 1.65160 | 58.54 | 43.93 |
| | 30 | −46.0652 | 43.5421 | | | 44.76 |
| | 31 | −40.8002 | 0.8388 | 1.77250 | 49.62 | 20.93 |
| | 32 | −128.8647 | DD[32] | | | 20.98 |
| | 33 | 101.1471 | 2.3277 | 1.60738 | 56.82 | 20.98 |
| | 34 | −101.1471 | DD[34] | | | 20.88 |
| | 35(St) | ∞ | 9.4776 | | | 19.00 |
| | 36 | −55.8219 | 0.6643 | 1.85451 | 25.15 | 18.53 |
| | 37 | 48.9976 | 0.0710 | | | 18.84 |
| | 38 | 52.5645 | 3.2091 | 1.49700 | 81.61 | 18.84 |
| | 39 | −52.5645 | 0.0701 | | | 19.23 |
| | 40 | 49.8440 | 8.4760 | 1.49700 | 81.61 | 20.01 |
| | 41 | −89.4934 | DD[41] | | | 20.84 |
| | 42 | 43.6998 | 3.5418 | 1.86966 | 20.02 | 27.48 |
| | 43 | ∞ | 17.3981 | | | 27.32 |
| | 44 | ∞ | 1.3986 | 1.48749 | 70.44 | |
| | 45 | ∞ | 18.9511 | 1.51680 | 64.20 | |
| | 46 | ∞ | | | | |

TABLE 8
Example 3

| | WIDE | MIDDLE | TELE |
|---|---|---|---|
| Zoom Ratio | 1.0 | 1.0 | 1.0 |
| \|Focal Length\| | 4.19 | 4.33 | 4.59 |
| Back Focus | 30.81 | 30.81 | 30.81 |
| Open F-Number | 2.21 | 2.22 | 2.24 |
| Maximum Total Angle of | 134.6 | 133.2 | 131.0 |
| View [°] | | | |
| DD[32] | 8.4793 | 5.6670 | 1.1118 |
| DD[34] | 1.3993 | 3.7022 | 6.8761 |
| DD[41] | 22.3864 | 22.8959 | 24.2772 |

TABLE 9
Example 3

| Sn | 1 | 2 | 22 | 23 |
|---|---|---|---|---|
| KA | 3.3401616E−01 | −1.6331592E+01 | 1.0000000E+00 | 1.0000000E+00 |
| A3 | −4.4789689E−04 | −5.4718511E−05 | 0.0000000E+00 | 0.0000000E+00 |
| A4 | 3.4474037E−04 | 1.8643070E−04 | −1.4484004E−04 | −4.8519676E−05 |
| A5 | −2.2158620E−05 | −6.1288650E−06 | 1.0736035E−04 | 4.8572790E−05 |
| A6 | −1.6414949E−07 | −7.3199102E−07 | −3.0821091E−05 | −1.1379411E−05 |
| A7 | 8.1119437E−08 | 4.7192976E−08 | 4.7922552E−06 | 1.3546441E−06 |
| A8 | −2.4539629E−09 | 6.5996296E−10 | −3.8504391E−07 | −7.0294246E−08 |
| A9 | −1.1577137E−10 | −1.1220004E−10 | 4.7733574E−09 | −1.8778964E−09 |
| A10 | 7.8350001E−12 | 7.7310272E−13 | 2.0212613E−09 | 4.9385910E−10 |
| A11 | 7.1269231E−15 | 1.4126772E−13 | −1.6783931E−10 | −2.4694948E−11 |
| A12 | −1.0280140E−14 | −2.4108925E−15 | 1.2467678E−12 | −2.7427782E−13 |
| A13 | 1.6273902E−16 | −9.9305423E−17 | 5.1834626E−13 | 8.1284141E−14 |
| A14 | 6.3461660E−18 | 2.3334416E−18 | −2.4733765E−14 | −2.5844422E−15 |
| A15 | −1.8749297E−19 | 3.9758416E−20 | −2.7749799E−16 | −6.1470086E−17 |
| A16 | −1.3061478E−21 | −1.1409577E−21 | 4.9988138E−17 | 5.1871782E−18 |
| A17 | 8.7153387E−23 | −8.2957123E−24 | −9.0621741E−19 | −5.1435937E−20 |
| A18 | −3.4061815E−25 | 2.8116919E−25 | −2.5452841E−20 | −2.6891424E−21 |
| A19 | −1.5083630E−26 | 7.0889558E−28 | 1.0183373E−21 | 6.2880128E−23 |
| A20 | 1.4220265E−28 | −2.8040605E−29 | −8.5185747E−24 | −2.2919613E−25 |

### Example 4

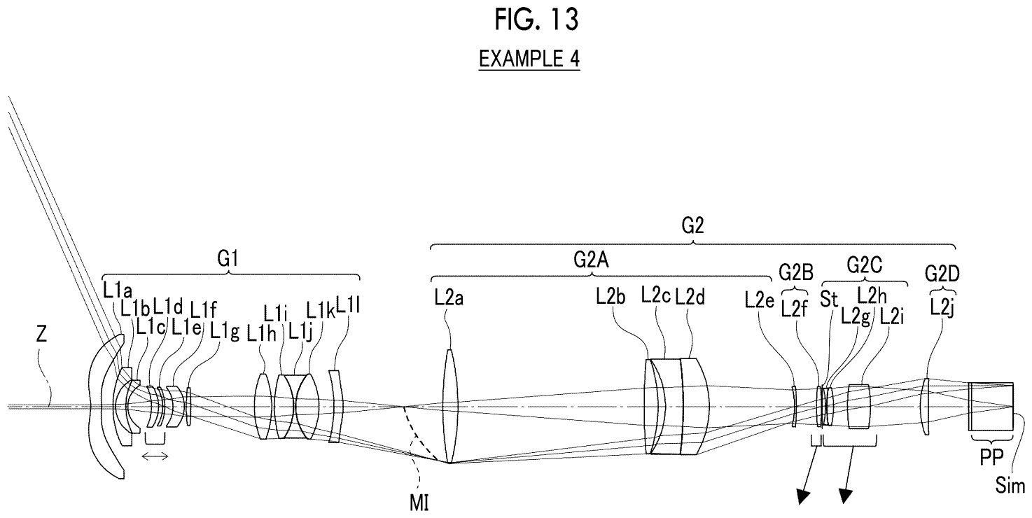

FIG. 13 shows a cross-sectional view of a configuration and luminous fluxes of an imaging optical system according to Example 4. The imaging optical system according to Example 4 is a variable magnification optical system, and consists of the first optical system G1 and the second optical system G2 in order from the enlargement side to the reduction side. The intermediate image MI is formed between the first optical system G1 and the second optical system G2. The second optical system G2 consists of a second A lens group G2A, a second B lens group G2B, a second C lens group G2C, and a second D lens group G2D along the optical path in order from the enlargement side to the reduction side. During changing magnification from the wide angle end to the telephoto end, the second B lens group G2B and the second C lens group G2C move along an optical axis Z while changing a mutual spacing, and all of the other lenses are fixed to the display surface Sim.

The first optical system G1 consists of lenses L1a to L1l in order from the enlargement side to the reduction side. The second A lens group G2A consists of lenses L2a to L2e in order from the enlargement side to the reduction side. The second B lens group G2B consists of a lens L2f. The second C lens group G2C consists of an aperture stop St and lenses L2g to L2i in order from the enlargement side to the reduction side. The second D lens group G2D consists of a lens L2j. The focus group consists of lenses L1d to L1e.

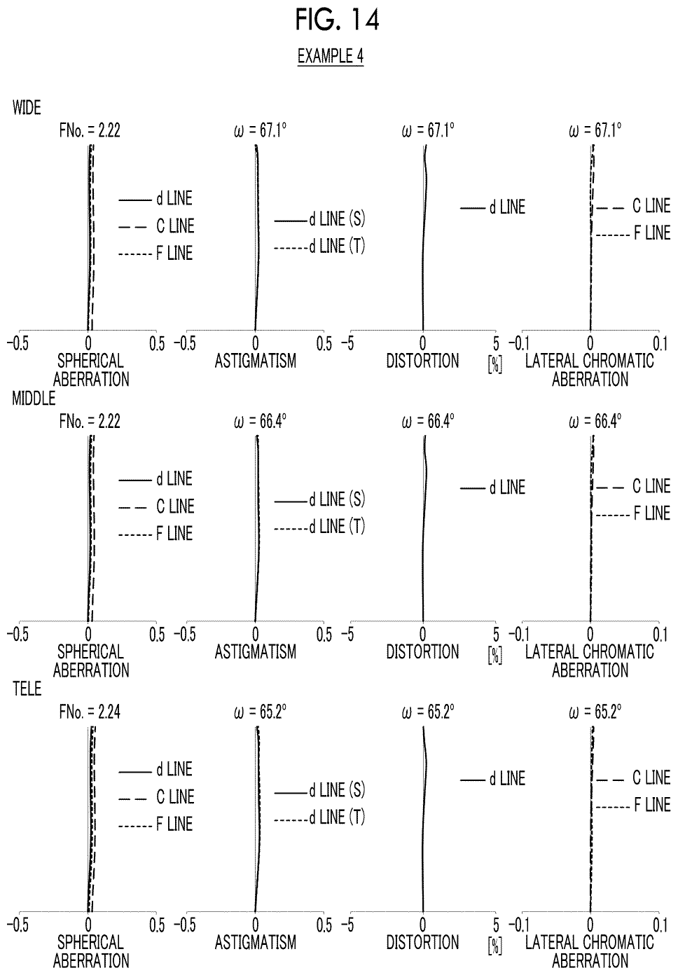

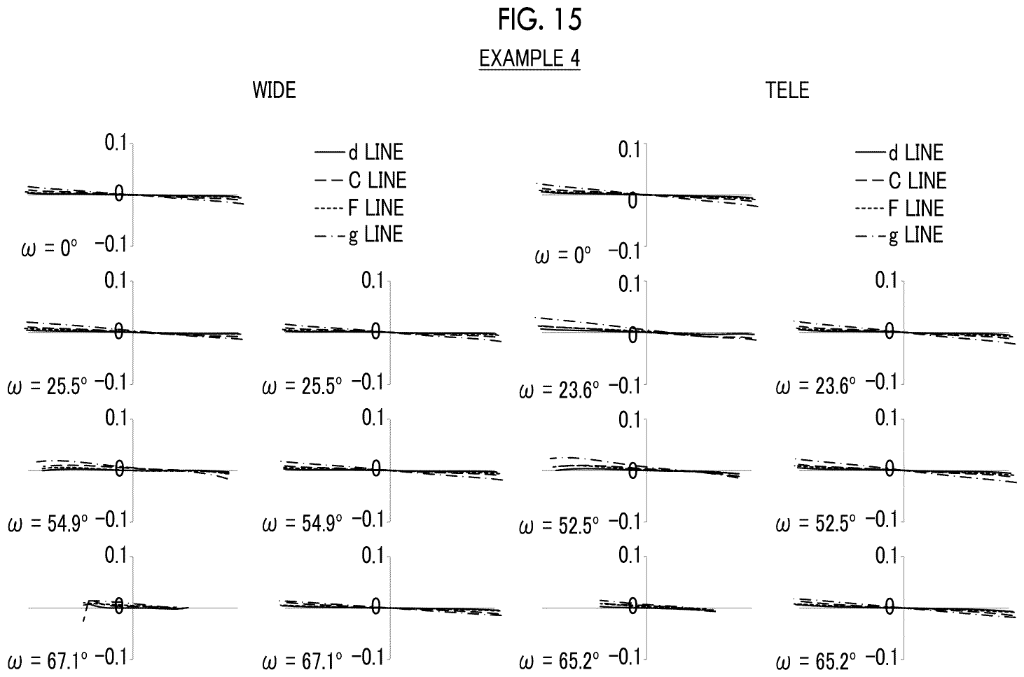

Regarding the imaging optical system according to Example 4, Tables 10A and 10B show basic lens data, Table 11 shows specifications and variable surface spacings during changing magnification, Table 12 shows aspherical coefficients, and FIGS. 14 and 15 show each of the aberration diagrams. The aberration diagrams are in a state where the projection distance is 790.2.

TABLE 10A
Example 4

| Sn | R | D | Nd | νd | ED |
|---|---|---|---|---|---|
| *1 | −24.0886 | 4.8945 | 1.53638 | 56.09 | 66.64 |
| *2 | −74.5715 | 5.2078 | | | 56.13 |
| 3 | 43.6828 | 1.1891 | 1.91082 | 35.25 | 37.36 |
| 4 | 14.7992 | 4.7195 | | | 25.68 |
| 5 | 28.7957 | 0.8392 | 1.89190 | 37.13 | 25.27 |
| 6 | 12.0835 | 10.8302 | | | 20.37 |
| 7 | −23.2589 | 3.1762 | 1.51680 | 64.20 | 19.29 |
| 8 | −18.3768 | 1.9189 | | | 19.44 |
| 9 | −18.1319 | 0.9499 | 1.85883 | 30.00 | 18.42 |
| 10 | −23.2586 | 3.7679 | | | 18.90 |
| 11 | −15.3591 | 5.1350 | 1.51742 | 52.43 | 18.38 |
| 12 | −15.5383 | 0.9298 | | | 20.16 |
| 13 | 88.8607 | 2.0404 | 1.86966 | 20.02 | 18.86 |
| 14 | −113.4041 | 11.9410 | | | 18.61 |
| Mr2 | ∞ | 17.0301 | | | |
| 15 | 44.3870 | 7.8987 | 1.48749 | 70.44 | 31.44 |
| 16 | −46.0327 | 1.2621 | | | 31.79 |
| 17 | 55.6363 | 8.7217 | 1.49700 | 81.61 | 31.02 |
| 18 | −27.7096 | 0.0215 | | | 30.49 |
| 19 | −27.6526 | 0.9784 | 1.84666 | 23.78 | 30.42 |
| 20 | 24.8970 | 10.5840 | 1.49700 | 81.61 | 30.80 |
| 21 | −33.2200 | 6.8187 | | | 31.39 |
| *22 | −50.8421 | 4.1952 | 1.51633 | 64.06 | 32.80 |
| *23 | −31.8876 | 45.4741 | | | 34.15 |

TABLE 10B
Example 4

| | Sn | R | D | Nd | νd | ED |
|---|---|---|---|---|---|---|
| LM | 24 | 162.9167 | 6.8681 | 1.80518 | 25.46 | 54.83 |
| | 25 | −121.8681 | 56.2136 | | | 55.01 |
| | Mr1 | ∞ | 28.405 | | | |
| LA | 26 | 265.8242 | 6.3568 | 1.80420 | 46.50 | 44.76 |
| | 27 | −71.6316 | 3.3748 | | | 44.49 |
| LB | 28 | −40.1379 | 8.1140 | 1.62004 | 36.26 | 44.24 |
| | 29 | −187.4334 | 11.8881 | 1.65160 | 58.54 | 45.17 |
| | 30 | −46.6096 | 38.8418 | | | 45.70 |
| | 31 | −38.9719 | 0.8386 | 1.69680 | 55.53 | 19.32 |
| | 32 | −116.6035 | DD[32] | | | 19.37 |
| | 33 | 100.2914 | 2.2726 | 1.51680 | 64.20 | 19.28 |
| | 34 | −104.2236 | DD[34] | | | 19.13 |
| | 35(St) | ∞ | 1.3933 | | | 16.99 |
| | 36 | −44.3217 | 0.6299 | 1.85451 | 25.15 | 17.01 |
| | 37 | 56.4297 | 0.0422 | | | 17.43 |
| | 38 | 59.5606 | 3.0522 | 1.49700 | 81.61 | 17.43 |
| | 39 | −39.6014 | 6.3475 | | | 17.90 |
| | 40 | 74.9530 | 10.4890 | 1.49700 | 81.61 | 20.09 |
| | 41 | −56.7049 | DD[41] | | | 20.94 |
| | 42 | 41.4417 | 3.6568 | 1.86966 | 20.02 | 26.76 |
| | 43 | 698.8625 | 11.0813 | | | 26.56 |
| | 44 | ∞ | 1.3986 | 1.48749 | 70.44 | |
| | 45 | ∞ | 18.9511 | 1.51680 | 64.20 | |
| | 46 | ∞ | | | | |

TABLE 11
Example 4

| | WIDE | MIDDLE | TELE |
|---|---|---|---|
| Zoom Ratio | 1.00 | 1.03 | 1.09 |
| \|Focal Length\| | 4.19 | 4.33 | 4.58 |
| Back Focus | 31.70 | 31.70 | 31.70 |
| Open F-Number | 2.22 | 2.22 | 2.24 |
| Maximum Total Angle of | 134.2 | 132.8 | 130.4 |
| View [°] | | | |
| DD[32] | 9.1670 | 5.8391 | 0.4318 |
| DD[34] | 0.3961 | 3.2997 | 7.7014 |
| DD[41] | 22.7325 | 23.1570 | 24.1624 |

TABLE 12
Example 4

| Sn | 1 | 2 | 22 | 23 |
|---|---|---|---|---|
| KA | 3.0389054E−01 | 3.1466941E+00 | 1.0000000E+00 | 1.0000000E+00 |
| A3 | −4.8048919E−04 | −3.1467701E−04 | 0.0000000E+00 | 0.0000000E+00 |
| A4 | 3.6246202E−04 | 2.5918633E−04 | −1.8729290E−04 | −3.9336131E−05 |
| A5 | −2.3205028E−05 | −6.9252957E−06 | 1.6565004E−04 | 7.1439173E−05 |
| A6 | −2.7481866E−07 | −1.4507439E−06 | −5.5484951E−05 | −2.1588585E−05 |
| A7 | 9.4213230E−08 | 9.2822011E−08 | 9.9627180E−06 | 3.2462187E−06 |
| A8 | −2.6646802E−09 | 2.1127681E−09 | −9.1446791E−07 | −2.1214755E−07 |
| A9 | −1.4644428E−10 | −2.9989742E−10 | 1.3401960E−08 | −5.5458341E−09 |
| A10 | 9.5396722E−12 | 6.7018399E−13 | 5.8547482E−09 | 1.8558152E−09 |
| A11 | 9.7837436E−15 | 5.2631098E−13 | −5.3554043E−10 | −9.6381761E−11 |
| A12 | −1.3233036E−14 | −7.3715799E−15 | 4.3018630E−12 | −2.0494689E−12 |
| A13 | 2.3527632E−16 | −5.2199785E−16 | 1.9918958E−12 | 4.0420712E−13 |
| A14 | 8.1835968E−18 | 1.0752231E−17 | −1.0646323E−13 | −1.1523928E−14 |
| A15 | −2.8725579E−19 | 3.0239819E−19 | −1.0659911E−15 | −3.9203926E−16 |
| A16 | −1.1928909E−21 | −7.6150628E−21 | 2.5845750E−16 | 3.0812328E−17 |
| A17 | 1.4104527E−22 | −9.2740908E−23 | −6.0778918E−18 | −4.1350636E−19 |
| A18 | −9.0507662E−25 | 2.6760705E−24 | −1.3985296E−19 | −1.7042365E−20 |
| A19 | −2.5744753E−26 | 1.1975388E−26 | 8.0666629E−21 | 6.4977447E−22 |
| A20 | 3.0701156E−28 | −3.8164616E−28 | −9.7379111E−23 | −6.5666264E−24 |

### Example 5

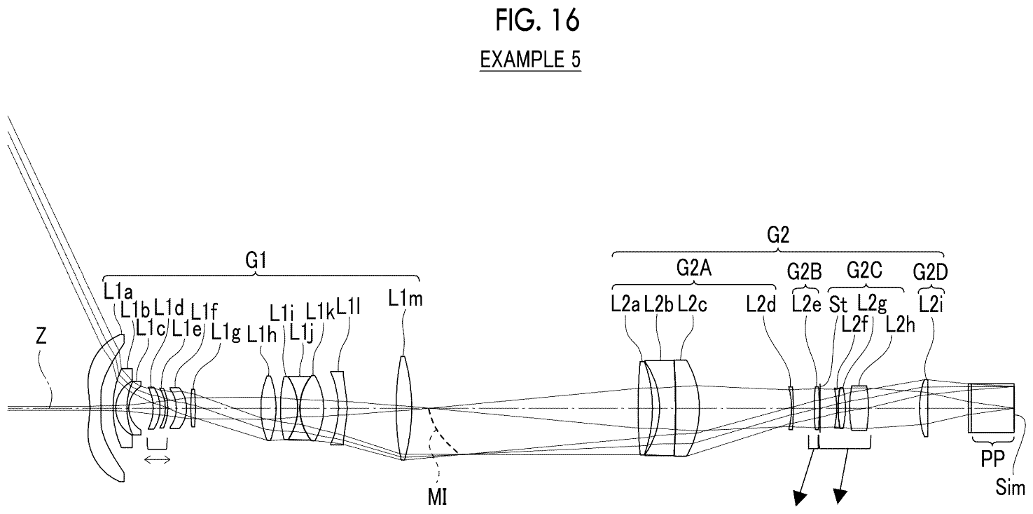

FIG. 16 shows a cross-sectional view of a configuration and luminous fluxes of an imaging optical system according to Example 5. The imaging optical system according to Example 5 is a variable magnification optical system, and consists of the first optical system G1 and the second optical system G2 in order from the enlargement side to the reduction side. The intermediate image MI is formed between the first optical system G1 and the second optical system G2. The second optical system G2 consists of a second A lens group G2A, a second B lens group G2B, a second C lens group G2C, and a second D lens group G2D along the optical path in order from the enlargement side to the reduction side. During changing magnification from the wide angle end to the telephoto end, the second B lens group G2B and the second C lens group G2C move along an optical axis Z while changing a mutual spacing, and all of the other lenses are fixed to the display surface Sim.

The first optical system G1 consists of lenses L1a to Lim in order from the enlargement side to the reduction side. The second A lens group G2A consists of lenses L2a G2B consists of a lens L2e. The second C lens group G2C consists of an aperture stop St and lenses L2f to L2h in order from the enlargement side to the reduction side. The second D lens group G2D consists of a lens L2i. The focus group consists of lenses L1d to L1e.

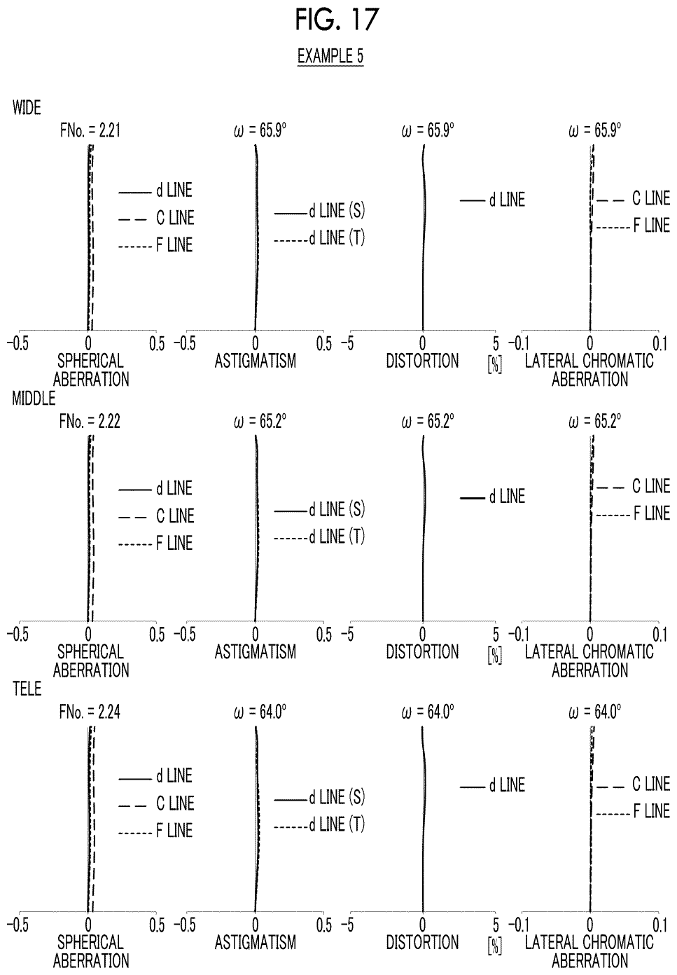

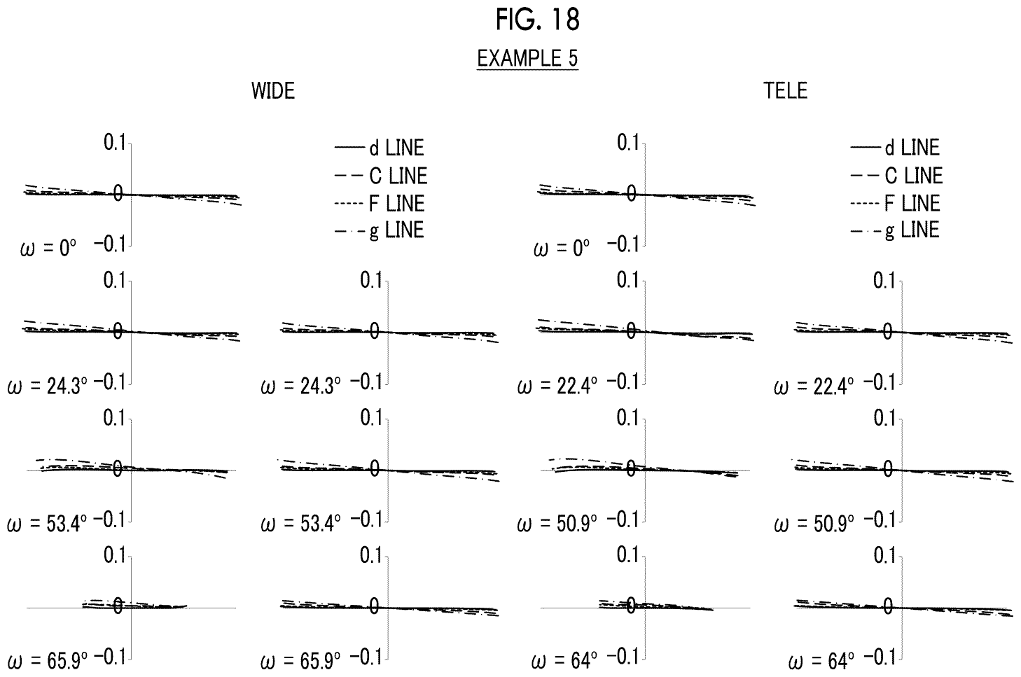

Regarding the imaging optical system according to Example 5, Tables 13A and 13B show basic lens data, Table 14 shows specifications and variable surface spacings during changing magnification, Table 15 shows aspherical coefficients, and FIGS. 17 and 18 show each of the aberration diagrams. The aberration diagrams are in a state where the projection distance is 790.2.

TABLE 13A
Example 5

| | Sn | R | D | Nd | νd | ED |
|---|---|---|---|---|---|---|
| | *1 | −24.1621 | 4.8629 | 1.53638 | 56.09 | 65.12 |
| | *2 | −73.4472 | 5.3207 | | | 53.76 |
| | 3 | 47.0513 | 1.1894 | 1.91082 | 35.25 | 36.95 |
| | 4 | 14.6387 | 4.9521 | | | 25.41 |
| | 5 | 31.4574 | 0.8397 | 1.74100 | 52.60 | 25.08 |
| | 6 | 12.2906 | 10.7898 | | | 20.31 |
| | 7 | −22.4599 | 3.0698 | 1.59282 | 68.62 | 19.24 |
| | 8 | −18.4813 | 2.3227 | | | 19.54 |
| | 9 | −18.0274 | 1.0831 | 1.83481 | 42.72 | 18.32 |
| | 10 | −23.4157 | 3.7810 | | | 18.83 |
| | 11 | −15.5800 | 4.5418 | 1.51680 | 64.20 | 18.31 |
| | 12 | −15.4315 | 1.8555 | | | 19.83 |
| | 13 | 89.9075 | 2.0377 | 1.86966 | 20.02 | 18.26 |
| | 14 | −111.1409 | 11.9757 | | | 17.98 |
| | Mr2 | ∞ | 17.0254 | | | |
| | 15 | 42.0144 | 6.7115 | 1.48749 | 70.44 | 30.74 |
| | 16 | −47.0909 | 1.9573 | | | 30.90 |
| | 17 | 68.5697 | 7.6358 | 1.49700 | 81.61 | 30.07 |
| | 18 | −27.4807 | 0.0217 | | | 29.68 |
| | 19 | −27.4142 | 0.9790 | 1.84666 | 2318 | 29.65 |
| | 20 | 24.8367 | 10.5132 | 1.49700 | 81.61 | 30.23 |
| | 21 | −31.5829 | 6.5698 | | | 30.87 |
| | *22 | −33.0021 | 3.8478 | 1.51633 | 64.06 | 32.14 |
| | *23 | −33.1325 | 21.7160 | | | 34.15 |
| LM | 24 | 137.2918 | 6.8931 | 1.80518 | 25.46 | 48.33 |
| | 25 | −92.8473 | 64.1895 | | | 48.55 |

TABLE 13B
Example 5

| | Sn | R | D | Nd | νd | ED |
|---|---|---|---|---|---|---|
| | Mr1 | ∞ | 35.813 | | | |
| LA | 26 | 244.4098 | 6.3475 | 1.80420 | 46.50 | 43.53 |
| | 27 | −68.2468 | 3.1835 | | | 43.38 |
| LB | 28 | −39.2974 | 7.1449 | 1.58144 | 40.75 | 43.18 |
| | 29 | −332.0713 | 10.5194 | 1.65160 | 58.54 | 44.23 |
| | 30 | −46.4050 | 40.7836 | | | 44.70 |
| | 31 | −39.1194 | 0.8399 | 1.69680 | 55.53 | 20.10 |
| | 32 | −103.6929 | DD[32] | | | 20.19 |
| | 33 | 103.9635 | 2.3427 | 1.51680 | 64.20 | 20.14 |
| | 34 | −105.1222 | DD[34] | | | 20.00 |
| | 35(St) | ∞ | 7.2686 | | | 18.03 |
| | 36 | −45.6287 | 0.6297 | 1.85451 | 25.15 | 18.19 |
| | 37 | 56.8939 | 0.0651 | | | 18.65 |
| | 38 | 61.7251 | 3.1964 | 1.49700 | 81.61 | 18.66 |
| | 39 | −41.5796 | 1.8634 | | | 19.13 |
| | 40 | 58.6282 | 8.3322 | 1.49700 | 81.61 | 20.24 |
| | 41 | −65.8004 | DD[41] | | | 20.74 |
| | 42 | 43.5581 | 3.6648 | 1.86966 | 20.02 | 26.56 |
| | 43 | ∞ | 17.8801 | | | 26.39 |
| | 44 | ∞ | 1.3986 | 1.48749 | 70.44 | |
| | 45 | ∞ | 18.9511 | 1.51680 | 64.20 | |
| | 46 | ∞ | | | | |

TABLE 14
Example 5

| | WIDE | MIDDLE | TELE |
|---|---|---|---|
| Zoom Ratio | 1.00 | 1.04 | 1.09 |
| \|Focal Length\| | 4.43 | 4.59 | 4.85 |
| Back Focus | 31.29 | 31.29 | 31.29 |
| Open F-Number | 2.21 | 2.22 | 2.24 |
| Maximum Total Angle of | 131.8 | 130.4 | 128.0 |
| View [°] | | | |
| DD[32] | 9.1882 | 5.8085 | 0.3275 |
| DD[34] | 0.3501 | 3.2542 | 7.6229 |
| DD[41] | 22.6367 | 23.1124 | 24.2245 |

TABLE 15
Example 5

| Sn | 1 | 2 | 22 | 23 |
|---|---|---|---|---|
| KA | 3.1912544E−01 | 3.5798580E+00 | 1.0000000E+00 | 1.0000000E+00 |
| A3 | −2.8438658E−04 | −1.0221639E−04 | 0.0000000E+00 | 0.0000000E+00 |
| A4 | 3.4419158E−04 | 2.3711174E−04 | −1.0828506E−04 | −3.0682898E−05 |
| A5 | −2.4199996E−05 | −7.1240734E−06 | 1.0728903E−04 | 6.3252726E−05 |
| A6 | −6.9070068E−08 | −1.2966618E−06 | −3.3683359E−05 | −1.8764299E−05 |
| A7 | 9.0821238E−08 | 8.7850395E−08 | 5.6046751E−06 | 2.8235304E−06 |
| A8 | −3.4357380E−09 | 1.6185135E−09 | −4.6919552E−07 | −1.8893725E−07 |
| A9 | −1.1521499E−10 | −2.7400275E−10 | 5.2099382E−09 | −4.1053960E−09 |
| A10 | 1.0957375E−11 | 1.5406846E−12 | 2.5914165E−09 | 1.5658332E−09 |
| A11 | −8.2661597E−14 | 4.6202575E−13 | −2.0500312E−10 | −8.2984341E−11 |
| A12 | −1.4284922E−14 | −7.9774993E−15 | 1.0057986E−12 | −1.6312755E−12 |
| A13 | 3.7663219E−16 | −4.3771762E−16 | 6.4058148E−13 | 3.3375254E−13 |
| A14 | 7.7612854E−18 | 1.0601256E−17 | −3.0374142E−14 | −9.2413032E−15 |
| A15 | −4.0603154E−19 | 2.4093132E−19 | −2.4767801E−16 | −3.2763513E−16 |
| A16 | 9.0435609E−23 | −7.0984234E−21 | 6.1584007E−17 | 2.3953562E−17 |
| A17 | 1.9286788E−22 | −6.9780990E−23 | −1.5105654E−18 | −2.7315342E−19 |
| A18 | −1.7172325E−24 | 2.3885687E−24 | −2.3776472E−20 | −1.3483382E−20 |
| A19 | −3.4896102E−26 | 8.4771667E−27 | 1.6542611E−21 | 4.4704525E−22 |
| A20 | 4.8100671E−28 | −3.2766022E−28 | −2.1609472E−23 | −3.9638498E−24 |

### Example 6

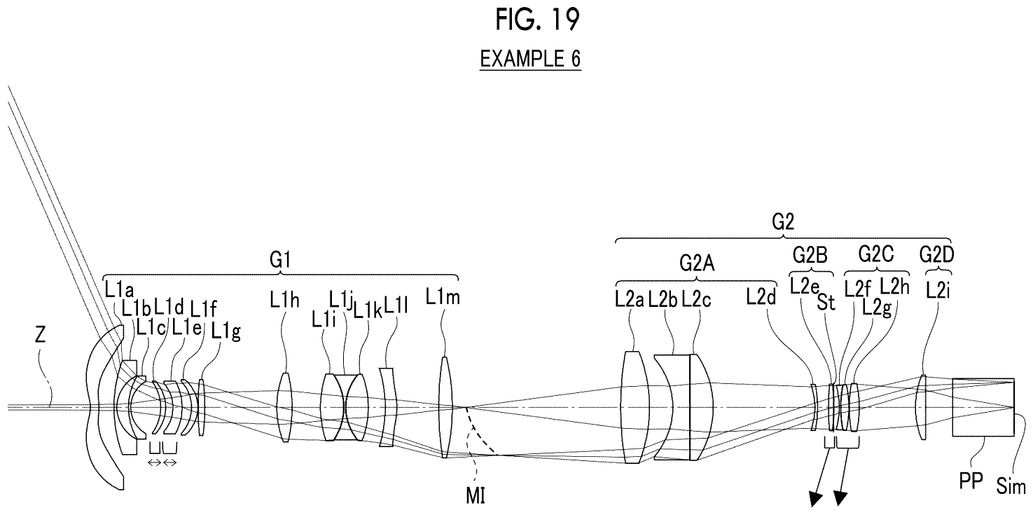

FIG. 19 shows a cross-sectional view of a configuration and luminous fluxes of an imaging optical system according to Example 6. The imaging optical system according to Example 6 is a variable magnification optical system, and consists of the first optical system G1 and the second optical system G2 in order from the enlargement side to the reduction side. The intermediate image MI is formed between the first optical system G1 and the second optical system G2. The second optical system G2 consists of a second A lens group G2A, a second B lens group G2B, a second C lens group G2C, and a second D lens group G2D along the optical path in order from the enlargement side to the reduction side. During changing magnification from the wide angle end to the telephoto end, the second B lens group G2B and the second C lens group G2C move along an optical axis Z while changing a mutual spacing, and all of the other lenses are fixed to the display surface Sim.

The first optical system G1 consists of lenses L1a to Lim in order from the enlargement side to the reduction side. The second A lens group G2A consists of lenses L2a G2B consists of a lens L2e and an aperture stop St in order from the enlargement side to the reduction side. The second C lens group G2C consists of lenses L2f to L2h in order from the enlargement side to the reduction side. The second D lens group G2D consists of a lens L2i. The imaging optical system according to Example 6 includes two focus groups that move while changing a mutual spacing during focusing. The focus group on the enlargement side consists of a lens L1d, and the focus group on the reduction side consists of a lens L1e.

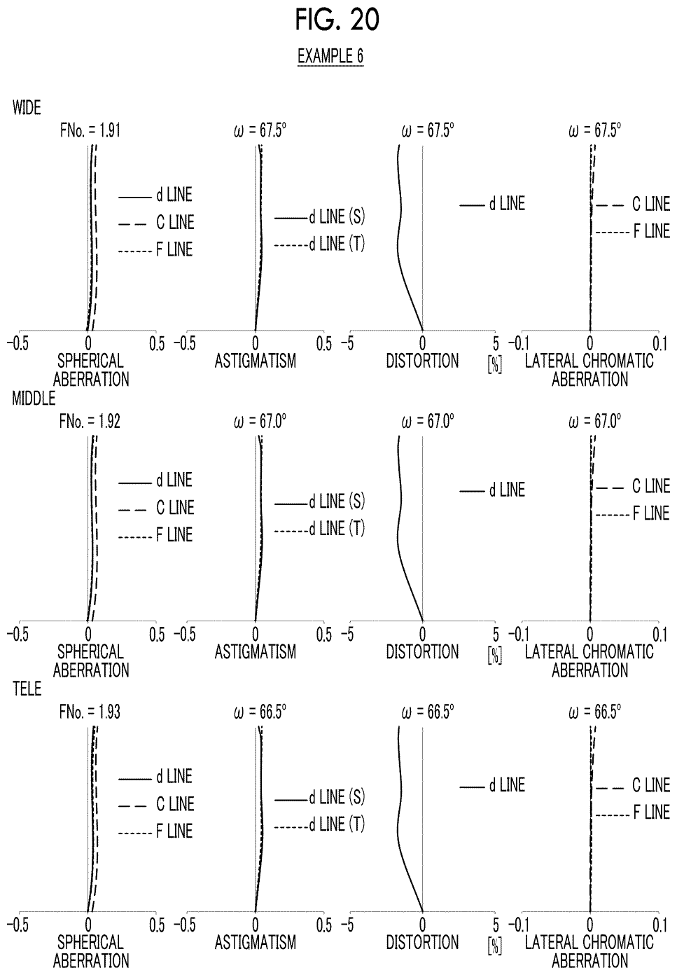

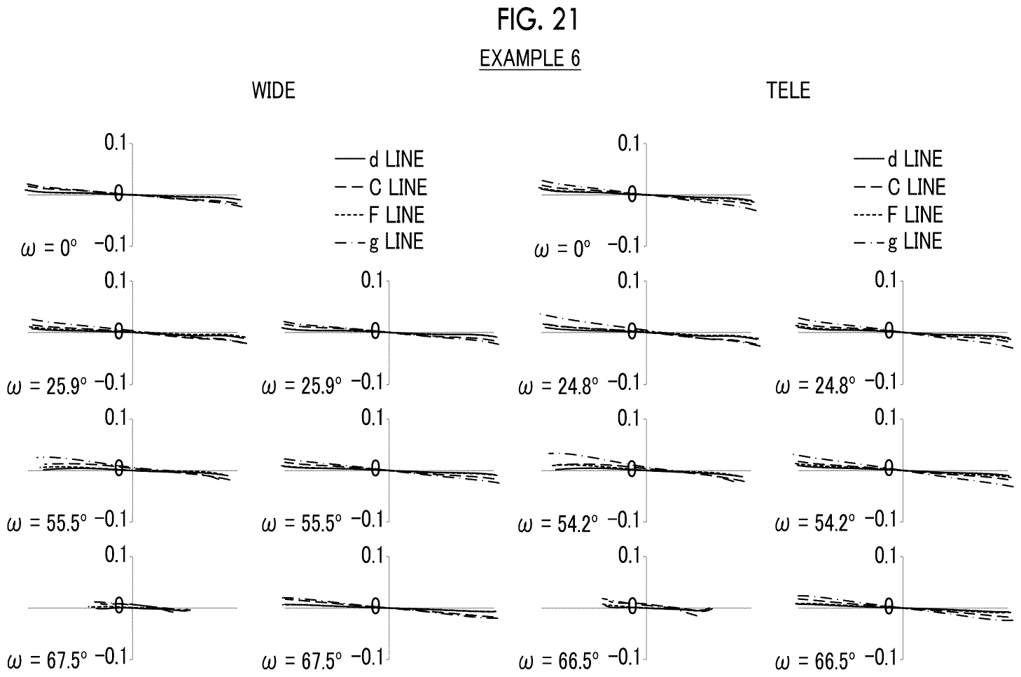

Regarding the imaging optical system according to Example 6, Tables 16A and 16B show basic lens data, Table 17 shows specifications and variable surface spacings during changing magnification, Table 18 shows aspherical coefficients, and FIGS. 20 and 21 show each of the aberration diagrams. The aberration diagrams are in a state where the projection distance is 614.1.

TABLE 16A
Example 6

| | Sn | R | D | Nd | νd | ED |
|---|---|---|---|---|---|---|
| | *1 | −14.4407 | 3.2609 | 1.53097 | 55.61 | 63.34 |
| | *2 | −33.3312 | 5.6717 | | | 52.54 |
| | 3 | 56.0929 | 1.0870 | 1.91082 | 35.25 | 37.52 |
| | 4 | 14.4385 | 4.4054 | | | 25.36 |
| | 5 | 25.7927 | 0.8148 | 1.80400 | 46.53 | 25.16 |
| | 6 | 12.3800 | 11.3278 | | | 20.94 |
| | 7 | −17.9364 | 1.8587 | 1.78880 | 28.43 | 20.33 |
| | 8 | −16.2090 | 2.7563 | | | 20.87 |
| | 9 | −15.0756 | 3.4593 | 1.71299 | 53.87 | 19.08 |
| | 10 | −22.9462 | 3.5656 | | | 20.89 |
| | 11 | −15.7972 | 2.3802 | 1.62299 | 58.16 | 20.98 |
| | 12 | −15.0362 | 0.1082 | | | 22.01 |
| | 13 | 122.7370 | 2.5469 | 1.80809 | 2216 | 22.37 |
| | 14 | −87.2009 | 13.0000 | | | 22.31 |
| | Mr2 | ∞ | 14.1744 | | | |
| | 15 | 38.9068 | 5.7743 | 1.49700 | 81.61 | 27.03 |
| | 16 | −62.6714 | 10.7149 | | | 27.17 |
| | 17 | 43.4425 | 8.8122 | 1.60311 | 60.64 | 26.14 |
| | 18 | −23.9027 | 0.7612 | 1.84666 | 23.78 | 26.04 |
| | 19 | 20.9136 | 8.4825 | 1.49700 | 81.61 | 25.15 |
| | 20 | −38.5600 | 6.4371 | | | 26.36 |
| | *21 | −39.9584 | 4.3473 | 1.51633 | 64.06 | 28.14 |
| | *22 | −27.1739 | 15.8484 | | | 29.83 |
| LM | 23 | 137.2988 | 5.1166 | 1.80518 | 25.46 | 40.48 |
| | 24 | −89.6827 | 35.0000 | | | 40.69 |

TABLE 16B
Example 6

| | Sn | R | D | Nd | νd | ED |
|---|---|---|---|---|---|---|
| | Mr1 | ∞ | 28.3591 | | | |
| LA | 25 | 134.5741 | 10.8694 | 1.80400 | 46.53 | 44.51 |
| | 26 | −63.8020 | 8.8101 | | | 44.10 |
| LB | 27 | −30.7083 | 6.5268 | 1.59270 | 35.31 | 39.02 |
| | 28 | −4401.1130 | 8.7194 | 1.72916 | 54.68 | 41.65 |
| | 29 | −39.0231 | 38.3701 | | | 42.12 |
| | 30 | −29.1355 | 1.0306 | 1.80610 | 40.93 | 18.35 |
| | 31 | −49.6433 | DD[31] | | | 18.49 |
| | 32 | 124.3550 | 1.9532 | 1.60311 | 60.64 | 17.71 |
| | 33 | −87.3748 | 0.0000 | | | 17.54 |
| | 34(St) | ∞ | DD[34] | | | 17.38 |
| | 35 | −33.4874 | 0.5440 | 1.78880 | 28.43 | 17.29 |
| | 36 | 47.9679 | 0.0434 | | | 17.75 |
| | 37 | 50.2739 | 3.0624 | 1.52841 | 76.45 | 17.75 |
| | 38 | −40.3013 | 0.1089 | | | 18.11 |
| | 39 | 56.2190 | 3.7777 | 1.49700 | 81.61 | 18.79 |
| | 40 | −46.4276 | DD[40] | | | 19.02 |
| | 41 | 36.2413 | 3.8040 | 1.86966 | 20.02 | 25.54 |
| | 42 | ∞ | 10.1649 | | | 25.38 |
| | 43 | ∞ | 23.2609 | 1.51633 | 64.14 | |
| | 44 | ∞ | | | | |

TABLE 17
Example 6

| | WIDE | MIDDLE | TELE |
|---|---|---|---|
| Zoom Ratio | 1.00 | 1.02 | 1.05 |
| \|Focal Length\| | 4.19 | 4.29 | 4.39 |
| Back Focus | 25.48 | 25.48 | 25.48 |
| Open F-Number | 1.91 | 1.92 | 1.93 |
| Maximum Total Angle of | 135.0 | 134.0 | 133.0 |
| View [°] | | | |
| DD[31] | 4.1654 | 2.1873 | 0.2718 |
| DD[34] | 2.1081 | 3.6779 | 5.1373 |
| DD[40] | 21.2647 | 21.6729 | 22.1291 |

TABLE 18
Example 6

| Sn | 1 | 2 | 21 | 22 |
|---|---|---|---|---|
| KA | 1.8705499E−01 | 1.1142204E+00 | 1.0000000E+00 | 1.0000000E+00 |
| A3 | −1.4379012E−03 | −4.9050615E−04 | −3.4952468E−04 | −1.3483649E−04 |
| A4 | 8.6004117E−04 | 4.0709985E−04 | 1.9615315E−04 | 1.5328897E−04 |
| A5 | −6.0104203E−05 | 2.7095621E−06 | −1.1306850E−05 | −7.5917113E−07 |
| A6 | −1.5208520E−06 | −4.1169505E−06 | −3.9336371E−06 | −2.4126558E−06 |
| A7 | 3.8362672E−07 | 1.5012960E−07 | 8.1277997E−07 | 3.3866076E−07 |
| A8 | −9.8946393E−09 | 1.4550624E−08 | −4.7305208E−08 | −4.3013040E−09 |
| A9 | −9.8053685E−10 | −8.8686842E−10 | −4.4761293E−09 | −3.0968332E−09 |
| A10 | 5.9944721E−11 | −2.8795825E−11 | 5.0118012E−10 | 1.9514578E−10 |
| A11 | 6.3231944E−13 | 2.7888015E−12 | 1.8313584E−11 | 1.2377470E−11 |
| A12 | −1.2991099E−13 | 1.5160401E−14 | −3.3948110E−12 | −1.3507076E−12 |
| A13 | 1.7544831E−15 | −4.7390325E−15 | −8.8390704E−15 | −2.1023796E−14 |
| A14 | 1.3055204E−16 | 3.3093016E−17 | 1.1620881E−14 | 4.5803619E−15 |
| A15 | −3.8744035E−18 | 4.6287118E−18 | −9.2483998E−17 | 1.8176234E−18 |
| A16 | −4.7540110E−20 | −6.7260961E−20 | −2.2849605E−17 | −8.5448663E−18 |
| A17 | 2.9492311E−21 | −2.3489718E−21 | 2.3483649E−19 | 3.5152847E−20 |
| A18 | −1.1688723E−23 | 4.5315887E−23 | 2.3697703E−20 | 8.4527177E−21 |
| A19 | −8.0866608E−25 | 4.9786660E−25 | −1.4857769E−22 | −2.8728751E−23 |
| A20 | 9.4336825E−27 | −1.1255164E−26 | −1.1000375E−23 | −3.5010014E−24 |

### Example 7

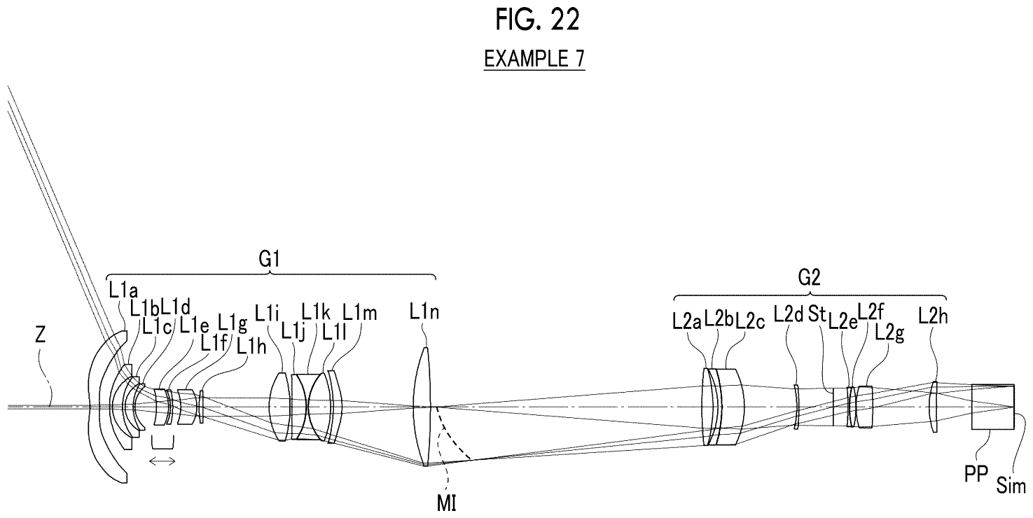

FIG. 22 shows a cross-sectional view of a configuration and luminous fluxes of an imaging optical system according to Example 7. The imaging optical system according to Example 7 is a fixed focal point optical system, and consists of the first optical system G1 and the second optical system G2 in order from the enlargement side to the reduction side. The intermediate image MI is formed between the first optical system G1 and the second optical system G2.

The first optical system G1 consists of lenses L1a to Lin in order from the enlargement side to the reduction side. The second optical system G2 consists of lenses L2a to L2d, an aperture stop St, and lenses L2e to L2h in order from the enlargement side to the reduction side. The focus group consists of lenses L1e to L1f.

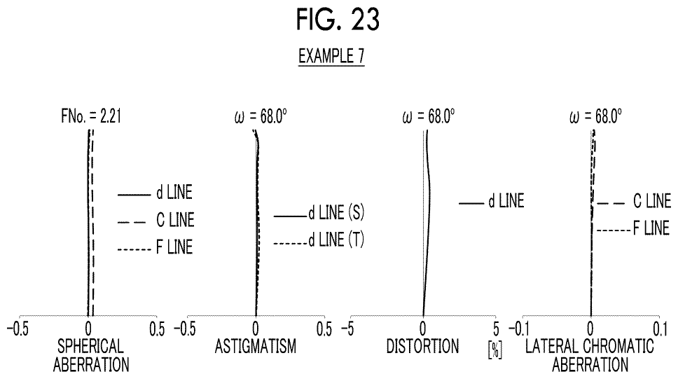

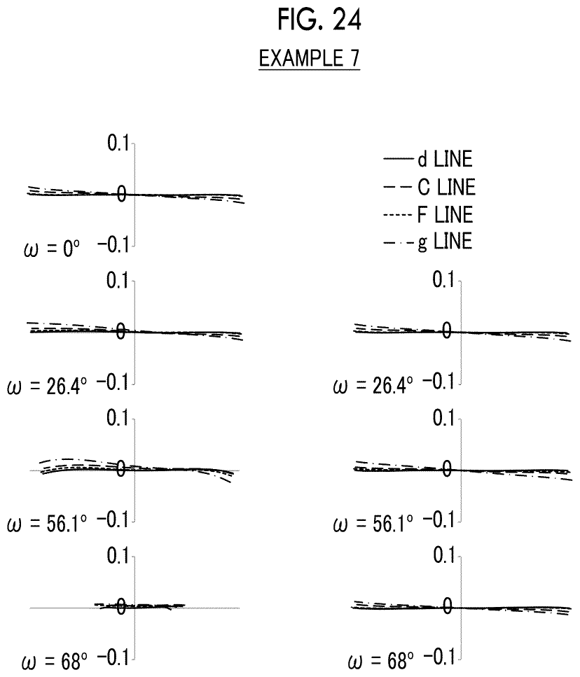

Regarding the imaging optical system according to Example 7, Tables 19A and 19B show basic lens data, Table 20 shows specifications, Table 21 shows aspherical coefficients, and FIGS. 23 and 24 show each of the aberration diagrams. The aberration diagrams are in a state where the projection distance is 753.3.

TABLE 19A
Example 7

| | Sn | R | D | Nd | νd | ED |
|---|---|---|---|---|---|---|
| | *1 | −23.9036 | 4.3846 | 1.50872 | 56.36 | 70.34 |
| | *2 | −54.5208 | 4.5391 | | | 58.42 |
| | 3 | 34.0268 | 1.3333 | 1.83481 | 42.72 | 41.47 |
| | 4 | 16.9068 | 4.6008 | | | 30.10 |
| | 5 | 25.3256 | 1.2000 | 1.90366 | 31.31 | 29.62 |
| | 6 | 13.2379 | 3.7005 | | | 23.13 |
| | 7 | 21.9005 | 0.8333 | 1.72916 | 54.54 | 22.95 |
| | 8 | 13.1769 | 9.8487 | | | 20.23 |
| | 9 | −34.2557 | 5.4905 | 1.72916 | 54.54 | 18.44 |
| | 10 | −20.9236 | 0.8942 | | | 18.30 |
| | 11 | −20.3597 | 1.0707 | 1.80610 | 33.27 | 17.25 |
| | 12 | −39.6760 | 3.6753 | | | 17.32 |
| | 13 | −21.9202 | 7.3328 | 1.48749 | 70.44 | 16.52 |
| | 14 | −17.2226 | 1.0504 | | | 17.89 |
| | 15 | 52.1490 | 1.6988 | 1.86966 | 20.02 | 16.67 |
| | 16 | 444.0087 | 12.6756 | | | 16.33 |
| | Mr2 | ∞ | 17.7104 | | | |
| | 17 | 31.8403 | 9.5705 | 1.49700 | 81.61 | 33.56 |
| | 18 | −61.2768 | 0.8516 | | | 33.31 |
| | 19 | −2787.8838 | 6.5872 | 1.48749 | 70.44 | 31.92 |
| | 20 | −29.4176 | 0.9667 | 1.84666 | 23.84 | 31.30 |
| | 21 | 25.1421 | 10.1903 | 1.49700 | 81.61 | 31.74 |
| | 22 | −46.9818 | 1.2381 | | | 32.64 |
| | *23 | −64.3645 | 4.0005 | 1.49710 | 81.56 | 33.51 |
| | *24 | −29.9790 | 32.6162 | | | 34.90 |
| LM | 25 | 83.9854 | 7.8956 | 1.84666 | 23.84 | 58.16 |
| | 26 | −319.0449 | 79.1350 | | | 58.09 |

TABLE 19B
Example 7

| | Sn | R | D | Nd | νd | ED |
|---|---|---|---|---|---|---|
| | Mr1 | ∞ | 44.879 | | | |
| LA | 27 | 173.3464 | 5.1133 | 1.80420 | 46.50 | 37.22 |
| | 28 | −70.5883 | 2.2492 | | | 36.93 |
| LB | 29 | −40.0350 | 1.8118 | 1.60342 | 38.03 | 36.71 |
| | 30 | −66.2462 | 10.3262 | 1.58913 | 61.13 | 36.53 |
| | 31 | −43.0144 | 24.0559 | | | 36.03 |
| | 32 | −43.7387 | 0.8988 | 1.71299 | 53.87 | 21.54 |
| | 33 | −123.2745 | 15.8258 | | | 21.45 |
| | 34(St) | ∞ | 6.6974 | | | 18.13 |
| | 35 | −98.3845 | 0.6333 | 1.85451 | 25.15 | 18.63 |
| | 36 | 44.2924 | 0.0836 | | | 18.91 |
| | 37 | 48.0149 | 2.9279 | 1.49700 | 81.61 | 18.91 |
| | 38 | −45.5870 | 0.0671 | | | 19.19 |
| | 39 | 36.9988 | 7.6116 | 1.49700 | 81.61 | 19.99 |
| | 40 | −136.7475 | 25.8498 | | | 20.14 |
| | 41 | 39.9698 | 3.3543 | 1.86966 | 20.02 | 24.42 |
| | 42 | 400.3019 | 16.1549 | | | 24.25 |
| | 43 | ∞ | 19.4000 | 1.51680 | 64.20 | |
| | 44 | ∞ | | | | |

TABLE 20
Example 7

| | |
|---|---|
| \|Focal Length\| | 4.00 |
| Back Focus | 28.93 |
| Open F-Number | 2.21 |
| Maximum Total Angle of | 136.0 |
| View [°] | |

TABLE 21
Example 7

| Sn | 1 | 2 | 23 | 24 |
|---|---|---|---|---|
| KA | 2.8020654E−01 | −2.0998602E+01 | 1.0000000E+00 | 1.0000000E+00 |
| A3 | 3.8696330E−04 | 5.3155241E−04 | 0.0000000E+00 | 0.0000000E+00 |
| A4 | 2.5617852E−04 | 1.7296363E−04 | −1.9425116E−04 | −1.3309442E−04 |
| A5 | −2.0655117E−05 | −9.4215040E−06 | 1.3365624E−04 | 9.1922500E−05 |
| A6 | 1.3612032E−07 | −7.2876102E−07 | −4.2473095E−05 | −2.5416657E−05 |
| A7 | 6.1257611E−08 | 6.7646353E−08 | 7.3766984E−06 | 3.7002718E−06 |
| A8 | −2.6254743E−09 | 3.5817049E−10 | −6.5069513E−07 | −2.3486000E−07 |
| A9 | −5.7031220E−11 | −1.7292775E−10 | 8.1288951E−09 | −7.2121671E−09 |
| A10 | 6.5625100E−12 | 2.2643103E−12 | 3.9972964E−09 | 2.2284133E−09 |
| A11 | −6.5865565E−14 | 2.3794493E−13 | −3.3889549E−10 | −1.1819265E−10 |
| A12 | −7.1261810E−15 | −5.4864700E−15 | 1.3610093E−12 | −2.5212365E−12 |
| A13 | 1.9388446E−16 | −1.8282588E−16 | 1.2304498E−12 | 5.2619377E−13 |
| A14 | 3.1960481E−18 | 5.5328369E−18 | −5.6477677E−14 | −1.5861803E−14 |
| A15 | −1.7426687E−19 | 7.9679123E−20 | −9.3309368E−16 | −5.3137982E−16 |
| A16 | 1.8826190E−22 | −2.9474872E−21 | 1.3470801E−16 | 4.4284366E−17 |
| A17 | 7.1045411E−23 | −1.7950522E−23 | −2.2902264E−18 | −6.1668715E−19 |
| A18 | −6.2979165E−25 | 8.0438217E−25 | −8.2063528E−20 | −2.5988227E−20 |
| A19 | −1.1129329E−26 | 1.6394251E−27 | 3.1666078E−21 | 1.0028388E−21 |
| A20 | 1.4906145E−28 | −8.9456066E−29 | −2.6373135E−23 | −1.0009414E−23 |

Table 22 shows the corresponding values of Conditional Expressions (1) to (10) and the value of Ymax regarding the imaging optical systems according to Examples 1 to 7. Preferable ranges of the conditional expressions may be set by using the corresponding values of the examples shown in Table 22 as the upper limits or the lower limits of the conditional expressions.

TABLE 22

| Expression | | | | | |
|---|---|---|---|---|---|
| No. | | Example 1 | Example 2 | Example 3 | Example 4 |
| (1) | tanωm | 2.39 | 2.48 | 2.39 | 2.37 |
| (2) | (RAf + RAr)/(RAf − RAr) | 0.355 | 0.429 | 0.413 | 0.575 |
| (3) | (RAr + RBf)/(RAr − RBf) | 3.13 | 3.54 | 3.21 | 3.55 |
| (4) | Dmax/\|f\| | 27.48 | 30.86 | 27.06 | 20.20 |
| (5) | DAB/Ymax | 0.336 | 0.303 | 0.336 | 0.337 |
| (6) | NA/NB | 1.11 | 1.11 | 1.11 | 1.11 |
| (7) | DR/Ymax | 16.60 | 16.72 | 18.59 | 15.80 |
| (8) | DMr12/Ymax | 15.63 | 16.37 | 15.63 | 16.61 |
| (9) | fz/\|fw\| | 19.86 | 20.89 | 19.96 | 23.69 |
| (10) | Bf/\|f\| | 7.25 | 7.17 | 7.35 | 7.57 |
| | Ymax | 10 | 10 | 10 | 10 |

| Expression | | | | |
|---|---|---|---|---|
| No. | | Example 5 | Example 6 | Example 7 |
| (1) | tanωm | 2.24 | 2.41 | 2.48 |
| (2) | (RAf + RAr)/(RAf − RAr) | 0.563 | 0.357 | 0.421 |
| (3) | (RAr + RBf)/(RAr − RBf) | 3.71 | 2.86 | 3.62 |
| (4) | Dmax/\|f\| | 22.57 | 15.12 | 31.00 |
| (5) | DAB/Ymax | 0.318 | 0.881 | 0.225 |
| (6) | NA/NB | 1.14 | 1.13 | 1.13 |
| (7) | DR/Ymax | 16.42 | 14.35 | 15.24 |
| (8) | DMr12/Ymax | 14.81 | 11.55 | 17.08 |
| (9) | fz/\|fw\| | 22.92 | 20.38 | |
| (10) | Bf/\|f\| | 7.06 | 6.08 | 7.23 |
| | Ymax | 10 | 10 | 10 |

The imaging optical systems according to Examples 1 to 7 have a wide angle of view which is a total angle of view of 120 degrees or more at the wide angle end. The imaging optical systems according to Examples 1 to 7 implement a high-resolution optical system where various aberrations are favorably corrected.

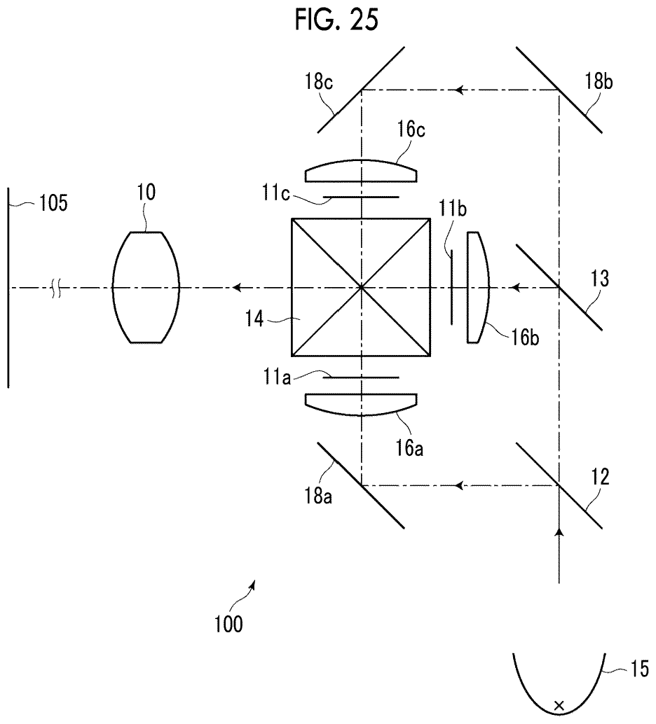

Next, a projection type display device according to an embodiment of the present disclosure will be described. FIG. 25 is a schematic configuration diagram showing the projection type display device according to an embodiment of the present disclosure. A projection type display device 100 shown in FIG. 25 includes an imaging optical system 10 according to the embodiment of the present disclosure, a light source 15, and transmissive display elements 11a to 11c as light valves corresponding to each color light and outputting an optical image. Further, the projection type display device 100 includes dichroic mirrors 12 and 13 for color separation, a cross dichroic prism 14 for color synthesis, condenser lenses 16a to 16c, and total reflection mirrors 18a to 18c for deflecting the optical path. In addition, FIG. 25 schematically shows the imaging optical system 10. Further, an integrator is disposed between the light source 15 and the dichroic mirror 12, but is not shown in FIG. 25.

White light emitted from the light source 15 is separated into three colored luminous fluxes (green light, blue light, and red light) through the dichroic mirrors 12 and 13. Next, the three colored luminous fluxes pass through the condenser lenses 16a to 16c, are incident into and modulated by the transmissive display elements 11a to 11c respectively corresponding to the respective colored luminous fluxes, are subjected to color synthesis by the cross dichroic prism 14, and are subsequently incident into the imaging optical system 10. The imaging optical system 10 projects an optical image, which is based on the modulated light modulated through the transmissive display elements 11a to 11c, onto a screen 105.

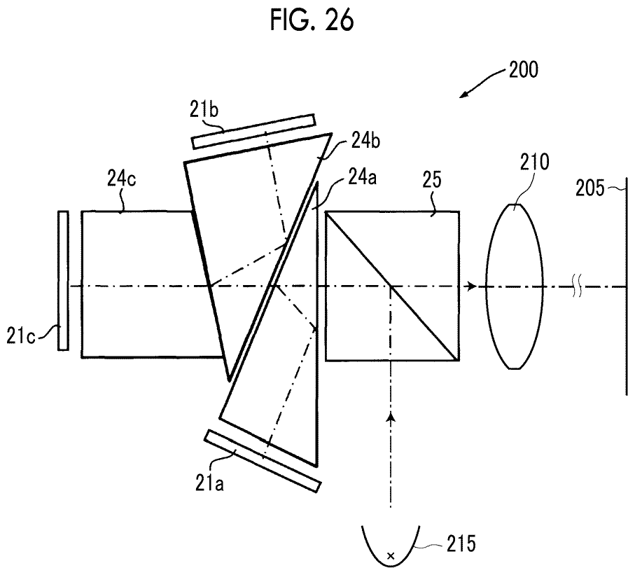

FIG. 26 is a schematic configuration diagram showing a projection type display device according to another embodiment of the present disclosure. A projection type display device 200 shown in FIG. 26 includes an imaging optical system 210 according to the embodiment of the present disclosure, a light source 215, and digital micromirror device (DMD: registered trademark) elements 21a to 21c as light valves corresponding to each color light and outputting an optical image. Further, the projection type display device 200 includes total internal reflection (TIR) prisms 24a to 24c for color separation and color synthesis, and a polarization separating prism 25 that separates illumination light and projection light. In addition, FIG. 26 schematically shows the imaging optical system 210. Further, an integrator is disposed between the light source 215 and the polarization separating prism 25, but is not shown in FIG. 26.

White light emitted from the light source 215 is reflected from a reflecting surface inside the polarization separating prism 25, and is separated into three colored luminous fluxes (green light, blue light, and red light) by the TIR prisms 24a to 24c. The separated colored luminous fluxes with the respective colors are respectively incident into and modulated through the corresponding DMD elements 21a to 21c, travel through the TIR prisms 24a to 24c again in a reverse direction, are subjected to color synthesis, are subsequently transmitted through the polarization separating prism 25, and are incident into the imaging optical system 210. The imaging optical system 210 projects an optical image, which is based on the modulated light modulated through the DMD elements 21a to 21c, onto a screen 205.

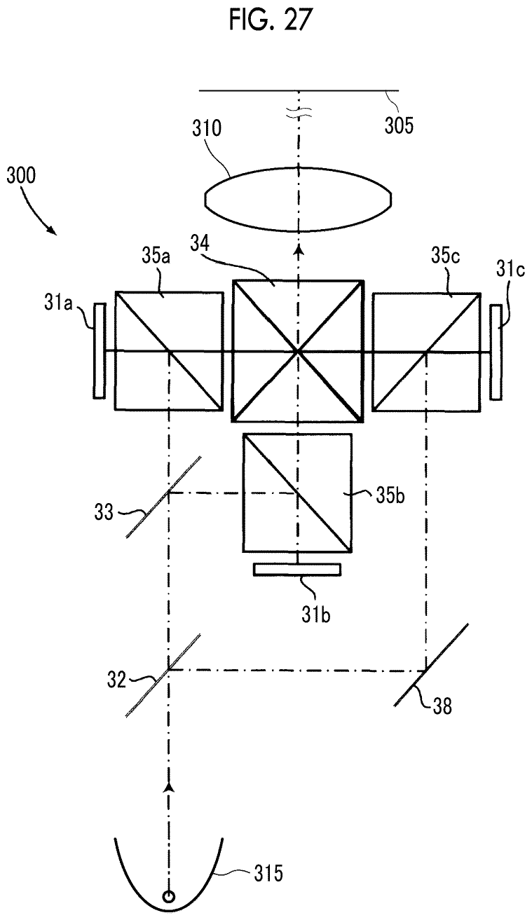

FIG. 27 is a schematic configuration diagram showing a projection type display device according to still another embodiment of the present disclosure. A projection type display device 300 shown in FIG. 27 includes an imaging optical system 310 according to the embodiment of the present disclosure, a light source 315, reflective display elements 31a to 31c as light valves each corresponding to each color light, dichroic mirrors 32 and 33 for color separation, a cross dichroic prism 34 for color synthesis, a total reflection mirror 38 for deflecting the optical path, and polarization separating prisms 35a to 35c. In addition, FIG. 27 schematically shows the imaging optical system 310. Further, an integrator is disposed between the light source 315 and the dichroic mirror 32, but is not shown in FIG. 27.

White light emitted from the light source 315 is separated into three colored luminous fluxes (green light, blue light, and red light) through the dichroic mirrors 32 and 33. The separated colored luminous fluxes with the respective colors respectively pass through the polarization separating prisms 35a to 35c, are incident into and modulated through the reflective display elements 31a to 31c respectively corresponding to the ray with the respective colors, are subjected to color synthesis through the cross dichroic prism 34, and are subsequently incident into the imaging optical system 310. The imaging optical system 310 projects an optical image, which is based on the modulated light modulated through the reflective display elements 31a to 31c, onto a screen 305.

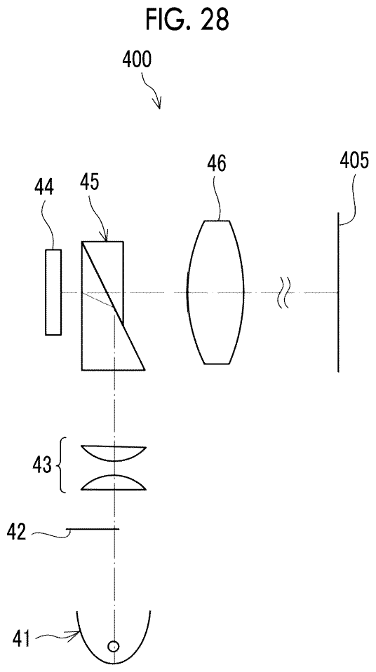

FIG. 28 is a schematic configuration diagram showing a projection type display device according to still another embodiment of the present disclosure. A projection type display device 400 shown in FIG. 28 includes an imaging optical system 46 according to the embodiment of the present disclosure, a light source 41, and a DMD element 44 as a light valve corresponding to each color light and outputting an optical image. Further, the projection type display device 400 includes a color wheel 42, a light guide optical system 43, and a TIR prism 45. In addition, FIG. 28 schematically shows the imaging optical system 46.

Filters having three colors of green, blue, and red are provided on a circumference of the color wheel 42. In a case where the color wheel 42 is rotated, the filters having the respective colors are sequentially inserted on the optical path. White light from the light source 41 is incident into the rotating color wheel 42 and is time-divided into colored luminous fluxes having three colors (green light, blue light, and red light). The colored luminous fluxes having the respective colors after the time-division pass through the light guide optical system 43 and the TIR prism 45, are incident into the DMD elements 44 to be modulated, and are incident into the imaging optical system 46 through the TIR prism 45 again. The imaging optical system 46 projects an optical image based on the modulated light modulated by the DMD element 44 onto a screen 405.

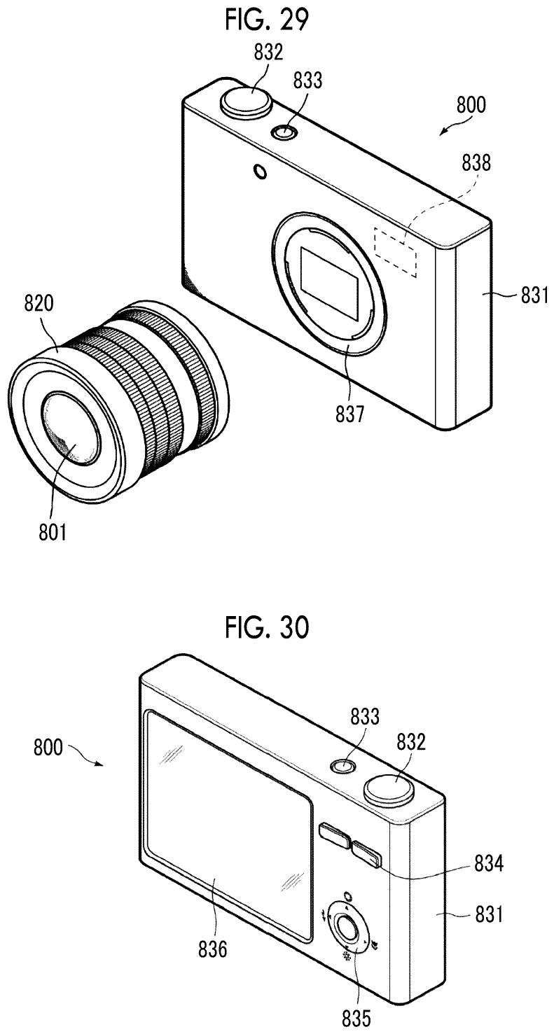

FIGS. 29 and 30 are external views showing a camera 800 that is an imaging apparatus according to an embodiment of the present disclosure. FIG. 29 is a perspective view showing the camera 800 in a view from the front side, and FIG. 30 is a perspective view showing the camera 800 in a view from the rear side. The camera 800 is a so-called mirrorless type digital camera, and an interchangeable lens 820 can be removably attached thereto. The interchangeable lens 820 is composed of an imaging optical system 801 according to an embodiment of the present disclosure accommodated in a lens barrel.

The camera 800 includes a camera body 831. A shutter button 832 and a power button 833 are provided on an upper surface of the camera body 831. Further, an operator 834, an operator 835 and a display unit 836 are provided on the rear surface of the camera body 831. The display unit 836 displays a captured image and an image within an angle of view before imaging.

An imaging aperture through which light from an imaging target is incident is provided at the center on the front surface of the camera body 831. A mount 837 is provided at a position corresponding to the imaging aperture. The interchangeable lens 820 is mounted on the camera body 831 with the mount 837 interposed therebetween.

An imaging element 838 is provided in the camera body 831. The imaging element 838 outputs an imaging signal corresponding to the subject image formed by the interchangeable lens 820. For example, a charge coupled device (CCD) or a complementary metal oxide semiconductor (CMOS) is used as the imaging element 838. A signal processing circuit (not shown), a recording medium (not shown), and the like are provided in the camera body 831. The signal processing circuit processes the imaging signal output from the imaging element 838 to generate an image. The recording medium is used to record the generated image. The camera 800 can capture a still image or a motion picture by pressing the shutter button 832, and records image data obtained through imaging in the recording medium.

The present disclosed technology has been hitherto described through embodiments and examples, but the technique of the present disclosure is not limited to the above-mentioned embodiments and examples, and may be modified into various forms. The curvature radius, the surface spacing, the refractive index, the Abbe number, the aspherical coefficient, and the like of each of the lenses are not limited to the values shown in the examples, and different values may be used therefor.

In addition, the projection type display device according to the present disclosed technology is not limited to the above-described configuration. For example, various changes of aspects can be made for the optical members and the light valves used for the luminous flux separation or the luminous flux synthesis. The light valve is not limited to an aspect in which light emitted from the light source is spatially modulated by an image display element and is output as an optical image based on image data, but may be an aspect in which light itself output from a light emitting image display element is output as an optical image based on the image data. Examples of the light emitting image display element include an image display element where light emitting elements such as light emitting diodes (LED) or organic light emitting diodes (OLED) are two-dimensionally arranged.

Further, an imaging apparatus according to the present disclosed technology is not limited to the above-described configuration, and can be modified into various aspects such as a non-mirrorless type camera, a film camera, a video camera, a security camera, and a camera for movie imaging.

Regarding the above-described embodiments and examples, the following supplementary notes will be further disclosed.

### Supplementary Note 1

An imaging optical system that forms an intermediate image at a position conjugate to a reduction-side imaging plane and re-forms the intermediate image on an enlargement-side imaging plane,
the imaging optical system consisting of a first optical system and a second optical system along an optical path in order from an enlargement side to a reduction side,
in which the intermediate image is formed between the first optical system and the second optical system, and
in a case where a lens disposed adjacent to the reduction side of a longest lens spacing that is a longest spacing among spacings on an optical axis between lenses in the imaging optical system is represented by an LA lens,
a lens disposed adjacent to the reduction side of the LA lens is represented by an LB lens,
a maximum half angle of view of the enlargement side is represented by om,
a curvature radius of an enlargement-side surface of the LA lens is represented by RAf,
a curvature radius of a reduction-side surface of the LA lens is represented by RAr,
a curvature radius of an enlargement-side surface of the LB lens is represented by RBf, and
each value of the longest lens spacing and om is set at a wide angle end in a case where the imaging optical system is a variable magnification optical system,
Conditional Expressions (1), (2), and (3) represented by

$$1.73 < tan ω m < 5 , \qquad ( 1 )$$

$$0 < ( RAf + RAr ) / ( RAf - RAr ) < 1.5 , and \qquad ( 2 )$$

$$1 < ( RAr + RBf ) / ( RAr - RBf ) < 10 \qquad ( 3 )$$

are satisfied.

### Supplementary Note 2

The imaging optical system according to Supplementary Note 1,
in which in a case where an air conversion distance of the longest lens spacing is represented by Dmax,
a focal length of the imaging optical system is represented by f, and
each value of Dmax and f is set at the wide angle end in a case where the imaging optical system is a variable magnification optical system,
Conditional Expression (4) represented by

$$10 < D max / \vert f \vert < 45 \qquad ( 4 )$$

is satisfied.

### Supplementary Note 3

The imaging optical system according to Supplementary Note 1 or 2,
in which in a case where a distance on the optical axis between the LA lens and the LB lens is represented by DAB,
a maximum image height on the reduction-side imaging plane is represented by Ymax, and
each value of DAB and Ymax is set at the wide angle end in a case where the imaging optical system is a variable magnification optical system,
Conditional Expression (5) represented by

$$0.1 < DAB / Y max < 1.5 \qquad ( 5 )$$

is satisfied.

### Supplementary Note 4

The imaging optical system according to any one of Supplementary Notes 1 to 3,
in which in a case where a refractive index of the LA lens with respect to a d line is represented by NA, and
a refractive index of the LB lens with respect to a d line is represented by NB,
Conditional Expression (6) represented by

$$1 < NA / NB < 1.3 \qquad ( 6 )$$

is satisfied.

### Supplementary Note 5

The imaging optical system according to any one of Supplementary Notes 1 to 4,
in which the LA lens and the LB lens are disposed in the second optical system.

### Supplementary Note 6

The imaging optical system according to any one of Supplementary Notes 1 to 5,
in which the LB lens is cemented to a lens disposed adjacent to the reduction side of the LB lens.

### Supplementary Note 7

The imaging optical system according to any one of Supplementary Notes 1 to 6,
in which in a case where a lens closest to the intermediate image on the optical axis is represented by an LM lens,
the LM lens is a positive lens.

### Supplementary Note 8

The imaging optical system according to Supplementary Note 7,
in which the LM lens is disposed adjacent to the enlargement side of the longest lens spacing.

### Supplementary Note 9

The imaging optical system according to any one of Supplementary Notes 1 to 8,
in which a first optical path deflection member that bends the optical path is disposed in the longest lens spacing.

### Supplementary Note 10

The imaging optical system according to Supplementary Note 9,
in which in a case where a distance on the optical axis from the first optical path deflection member to a lens surface closest to the reduction side in the second optical system is represented by DR,
a maximum image height on the reduction-side imaging plane is represented by Ymax, and
each value of DR and Ymax is set at the wide angle end in a case where the imaging optical system is a variable magnification optical system,
Conditional Expression (7) represented by

$$8 < DR / Y max < 26 \qquad ( 7 )$$

is satisfied.

### Supplementary Note 11

The imaging optical system according to any one of Supplementary Notes 1 to 10,
in which a second optical path deflection member that bends the optical path is disposed in the first optical system.

### Supplementary Note 12

The imaging optical system according to Supplementary Note 11,
in which in a case where a distance on the optical axis from the first optical path deflection member to the second optical path deflection member is represented by DMr12,
a maximum image height on the reduction-side imaging plane is represented by Ymax, and
each value of DMr12 and Ymax is set at the wide angle end in a case where the imaging optical system is a variable magnification optical system,
Conditional Expression (8) represented by

$$8 < DMr 12 / Y max < 30 \qquad ( 8 )$$

is satisfied.

### Supplementary Note 13

The imaging optical system according to any one of Supplementary Notes 1 to 12,
in which the imaging optical system is a variable magnification optical system,
one lens group is defined as a group of which a spacing to an adjacent group in an optical axis direction changes during changing magnification, and
the second optical system includes two or more lens groups that move during changing magnification.

### Supplementary Note 14

The imaging optical system according to Supplementary Note 13,
in which the number of lens groups that move during changing magnification in the second optical system is two.

### Supplementary Note 15

The imaging optical system according to Supplementary Note 13 or 14,
in which in a case where a focal length of a lens group where a movement amount from the wide angle end to a telephoto end during changing magnification is maximum is represented by fz, and
a focal length of the imaging optical system at the wide angle end is represented by fw,
Conditional Expression (9) represented by

$$10 < fz / \vert fw \vert < 30 \qquad ( 9 )$$

is satisfied.

### Supplementary Note 16

The imaging optical system according to any one of Supplementary Notes 1 to 15,
in which an enlargement-side lens surface of a lens closest to the enlargement side in the first optical system is an aspherical surface that has a concave surface facing the enlargement side in a paraxial region and has an inflection point where an uneven shape changes halfway from the optical axis toward a peripheral portion.

### Supplementary Note 17

The imaging optical system according to any one of Supplementary Notes 1 to 16,
wherein a reduction-side lens surface of a lens closest to the enlargement side in the first optical system is an aspherical surface that has a convex surface facing the reduction side in a paraxial region and has an inflection point where an uneven shape changes halfway from the optical axis toward a peripheral portion.

### Supplementary Note 18

The imaging optical system according to any one of Supplementary Notes 1 to 17,
in which the reduction side is telecentric.

### Supplementary Note 19

A projection type display device comprising:
the imaging optical system according to any one of Supplementary Notes 1 to 18.

### Supplementary Note 20

An imaging apparatus comprising:
the imaging optical system according to any one of Supplementary Notes 1 to 18.

What is claimed is:

1. An imaging optical system that forms an intermediate image at a position conjugate to a reduction-side imaging plane and re-forms the intermediate image on an enlargement-side imaging plane,
the imaging optical system consisting of a first optical system and a second optical system along an optical path in order from an enlargement side to a reduction side,
wherein the intermediate image is formed between the first optical system and the second optical system, and
in a case where a lens disposed adjacent to the reduction side of a longest lens spacing that is a longest spacing among spacings on an optical axis between lenses in the imaging optical system is represented by an LA lens,
a lens disposed adjacent to the reduction side of the LA lens is represented by an LB lens,
a maximum half angle of view of the enlargement side is represented by om,
a curvature radius of an enlargement-side surface of the LA lens is represented by RAf,
a curvature radius of a reduction-side surface of the LA lens is represented by RAr,
a curvature radius of an enlargement-side surface of the LB lens is represented by RBf, and
each value of the longest lens spacing and om is set at a wide angle end in a case where the imaging optical system is a variable magnification optical system,
Conditional Expressions (1), (2), and (3) represented by
$$1.73 < tan ω m < 5 , \qquad ( 1 )$$
$$0 < ( RAf + RAr ) / ( RAf - RAr ) < 1.5 , and \qquad ( 2 )$$
$$1 < ( RAr + RBf ) / ( RAr - RBf ) < 10 \qquad ( 3 )$$
are satisfied.

2. The imaging optical system according to claim 1,
wherein in a case where an air conversion distance of the longest lens spacing is represented by Dmax,
a focal length of the imaging optical system is represented by f, and
each value of Dmax and f is set at the wide angle end in a case where the imaging optical system is a variable magnification optical system,
Conditional Expression (4) represented by
$$10 < D max / \vert f \vert < 45 \qquad ( 4 )$$
is satisfied.

3. The imaging optical system according to claim 1,
wherein in a case where a distance on the optical axis between the LA lens and the LB lens is represented by DAB,
a maximum image height on the reduction-side imaging plane is represented by Ymax, and
each value of DAB and Ymax is set at the wide angle end in a case where the imaging optical system is a variable magnification optical system,
Conditional Expression (5) represented by
$$0.1 < DAB / Y max < 1.5 \qquad ( 5 )$$
is satisfied.

4. The imaging optical system according to claim 1,
wherein in a case where a refractive index of the LA lens with respect to a d line is represented by NA, and
a refractive index of the LB lens with respect to a d line is represented by NB,
Conditional Expression (6) represented by
$$1 < NA / NB < 1.3 \qquad ( 6 )$$
is satisfied.

5. The imaging optical system according to claim 1,
wherein the LA lens and the LB lens are disposed in the second optical system.

6. The imaging optical system according to claim 1,
wherein the LB lens is cemented to a lens disposed adjacent to the reduction side of the LB lens.

7. The imaging optical system according to claim 1,
wherein in a case where a lens closest to the intermediate image on the optical axis is represented by an LM lens,
the LM lens is a positive lens.

8. The imaging optical system according to claim 7,
wherein the LM lens is disposed adjacent to the enlargement side of the longest lens spacing.

9. The imaging optical system according to claim 1,
wherein a first optical path deflection member that bends the optical path is disposed in the longest lens spacing.

10. The imaging optical system according to claim 9,
wherein in a case where a distance on the optical axis from the first optical path deflection member to a lens surface closest to the reduction side in the second optical system is represented by DR,
a maximum image height on the reduction-side imaging plane is represented by Ymax, and
each value of DR and Ymax is set at the wide angle end in a case where the imaging optical system is a variable magnification optical system,
Conditional Expression (7) represented by
$$8 < DR / Y max < 26 \qquad ( 7 )$$
is satisfied.

11. The imaging optical system according to claim 9,
wherein a second optical path deflection member that bends the optical path is disposed in the first optical system.

12. The imaging optical system according to claim 11,
wherein in a case where a distance on the optical axis from the first optical path deflection member to the second optical path deflection member is represented by DMr12,
a maximum image height on the reduction-side imaging plane is represented by Ymax, and
each value of DMr12 and Ymax is set at the wide angle end in a case where the imaging optical system is a variable magnification optical system,
Conditional Expression (8) represented by
$$8 < DMr 12 / Y max < 30 \qquad ( 8 )$$
is satisfied.

13. The imaging optical system according to claim 1,
wherein the imaging optical system is a variable magnification optical system,
one lens group is defined as a group of which a spacing to an adjacent group in an optical axis direction changes during changing magnification, and
the second optical system includes two or more lens groups that move during changing magnification.

14. The imaging optical system according to claim 13,
wherein the number of lens groups that move during changing magnification in the second optical system is two.

15. The imaging optical system according to claim 13,
wherein in a case where a focal length of a lens group where a movement amount from the wide angle end to a telephoto end during changing magnification is maximum is represented by fz, and
a focal length of the imaging optical system at the wide angle end is represented by fw,
Conditional Expression (9) represented by
$$10 < fz / \vert fw \vert < 30 \qquad ( 9 )$$
is satisfied.

16. The imaging optical system according to claim 1,
wherein an enlargement-side lens surface of a lens closest to the enlargement side in the first optical system is an aspherical surface that has a concave surface facing the enlargement side in a paraxial region and has an inflection point where an uneven shape changes halfway from the optical axis toward a peripheral portion.

17. The imaging optical system according to claim 1,
wherein a reduction-side lens surface of a lens closest to the enlargement side in the first optical system is an aspherical surface that has a convex surface facing the reduction side in a paraxial region and has an inflection point where an uneven shape changes halfway from the optical axis toward a peripheral portion.

18. The imaging optical system according to claim 1,
wherein the reduction side is telecentric.

19. A projection type display device comprising:
the imaging optical system according to claim 1.

20. An imaging apparatus comprising:
the imaging optical system according to claim 1.
